(19) United States
(12) Patent Application Publication
(10) Pub. No.: US 2026/0370567 A1
(43) Pub. Date: Nov. 19, 2026

(54) SUPPORT FOR FEDERATED LEARNING (FL)

(71) Applicant: Telefonaktiebolaget LM Ericsson (publ), Stockholm (SE)

(72) Inventors: Jing YUE, Danderyd (SE); Zhang FU, Stockholm (SE); Ulf MATTSSON, Kungsbacka (SE); Tianmei LIANG, Shanghai (CN); Shabnam SULTANA, Montreal (CA); Antonio INIESTA GONZALEZ, Madrid (ES)

(73) Assignee: Telefonaktiebolaget LM Ericsson (publ), Stockholm (SE)

(21) Appl. No.: 19/144,223

(22) PCT Filed: Jan. 2, 2024
(86) PCT No.: PCT/CN2024/070117

§ 371 Date: Jun. 27, 2025

(30) Foreign Application Priority Data
Jan. 9, 2023 (WO) PCT/CN2023/071204

(51) Int. Cl. H04L 41/16

(52) U.S. Cl. CPC H04L 41/16

(57) ABSTRACT

The present disclosure is related to a server, a client, a network node and methods for supporting Federated Learning (FL). A method at a server associated with an FL process comprises at least one of: transmitting, to one or more clients that are associated with the FL process, a first message indicating that the corresponding client is unselected by the server for the FL process and/or the FL process is suspended; and receiving, from one or more second network nodes that are associated with the FL process, a second message indicating that the corresponding client is quitting the FL process.

### CROSS-REFERENCE TO RELATED APPLICATION(S)

This application claims priority to the PCT International Application No. PCT/CN2023/071204, entitled “SUPPORT FOR FEDERATED LEARNING (FL)”, filed on Jan. 9, 2023, which is incorporated herein by reference in their entireties.

### TECHNICAL FIELD

The present disclosure is related to the field of telecommunications, and in particular, to a server, a client, a network node and methods for supporting Federated Learning (FL).

### BACKGROUND

With the development of the electronic and telecommunication technologies, mobile devices, such as mobile phones, smart phones, laptops, tablets, vehicle mounted devices, become an important part of our daily lives. To support a numerous number of mobile devices, a highly efficient core network, such as a 3^{rd} Generation Partnership Project (3GPP) 5^{th} Generation Core (5GC), will be required.

Machine Learning (ML) is an important enabler for optimizing, securing, and managing core networks. This leads to increased collection and processing of data from network functions, which in turn may increase threats to sensitive end-user information. Consequently, mechanisms to reduce threats to end-user privacy are needed to take full advantage of ML.

As a new ML technology, Federated Learning (FL), also known as collaborative learning, trains an algorithm across multiple decentralized edge devices or servers holding local data samples, without exchanging them. This approach stands in contrast to traditional centralized machine learning techniques where all the local datasets are uploaded to one server, as well as to more classical decentralized approaches which often assume that local data samples are identically distributed.

Federated learning enables multiple actors to build a common, robust machine learning model without sharing data, thus allowing to address critical issues such as data privacy, data security, data access rights and access to heterogeneous data. Its applications are spread over a number of industries including defense, telecommunications, Internet of Things (IoT), and pharmaceutics.

Therefore, it becomes increasingly interesting to support FL in 3GPP 5GC.

### SUMMARY

According to the latest technical report from 3GPP, clause 8.8 of Technical Report (TR) 23.700-81 V2.0.0 (2022-11), the maintenance of FL process among multiple Network Data Analytics Functions (NWDAFs) in 5GC has been added into the conclusion (mainly in Principle 5) as follows:
Principle 5: NWDAF containing Model Training Logical Function (MTLF) as FL server may determine the final list of NWDAF containing MTLF as FL clients via initial FL request to FL clients to determine the availability and compatibility of the FL clients. During the FL procedure, the NWDAF containing MTLF as FL server may trigger reselection, addition or removal of FL clients and may issue a new FL client discovery via Network Repository Function (NRF), based on local policy or status of FL clients, e.g. load, availability, capability, latency, accuracy, etc. FL clients can join or quit FL operation dynamically in the execution phase.

However, how Server NWDAF gets the analytics of Client NWDAF(s) (e.g., Network Function (NF) load, etc.) and how to terminate the Federated Learning operation at Client NWDAF(s) are still unclear for the maintenance of FL process and implementation.

To address or at least alleviate the above problems, some embodiments of the present disclosure provide a server, a client, a network node and methods for supporting Federated Learning (FL) in a core network, such as a 5GC network.

According to a first aspect of the present disclosure, a method at a server associated with an FL process is provided. The method comprises at least one of: transmitting, to one or more clients that are associated with the FL process, a first message indicating that the corresponding client is unselected by the server for the FL process and/or the FL process is suspended; and receiving, from one or more clients that are associated with the FL process, a second message indicating that the corresponding client is quitting the FL process. In some embodiments, the method further comprises any of steps in any of the methods of the second aspect.

According to a second aspect of the present disclosure, a method at a server associated with an FL process is provided. The method comprises: receiving one or more fifth messages indicating analytics data, which is associated with one or more clients in the FL process and/or one or more candidate clients to be selected for the FL process; and selecting at least one from the one or more candidate clients and/or the one or more clients for the FL process based on at least the analytics data. In some embodiments, the method further comprises any of steps in any of the methods of the first aspect.

According to a third aspect of the present disclosure, a server is provided. The server comprises: a processor; a memory storing instructions which, when executed by the processor, cause the processor to perform any of the methods of the first and/or second aspects.

According to a fourth aspect of the present disclosure, a server associated with an FL process is provided. The server comprises at least one of: a transmitting module configured to transmit, to one or more clients that are associated with the FL process, a first message indicating that the corresponding client is unselected by the server for the FL process and/or the FL process is suspended; and a receiving module configured to receive, from one or more clients that are associated with the FL process, a second message indicating that the corresponding client is quitting the FL process. In some embodiments, the server comprises one or more further modules, each of which may perform any of the steps of any of the methods of the first aspect.

According to a fifth aspect of the present disclosure, a server associated with an FL process is provided. The server comprises: a receiving module configured to receive one or more fifth messages indicating analytics data, which is associated with one or more clients in the FL process and/or one or more candidate clients to be selected for the FL process; and a selecting module configured to select at least one from the one or more candidate clients and/or the one or more clients for the FL process based on at least the analytics data. In some embodiments, the server comprises one or more further modules, each of which may perform any of the steps of any of the methods of the second aspect.

According to a sixth aspect of the present disclosure, a method at a client associated with an FL process is provided. The method comprises at least one of: receiving, from a server that is associated with the FL process, a first message indicating that the client is unselected by the server for the FL process and/or the FL process is suspended; and transmitting, to a server that is associated with the FL process, a second message indicating that the client is quitting the FL process. In some embodiments, the method further comprises any of steps in any of the methods of seventh aspect.

According to a seventh aspect of the present disclosure, a method at a client that is associated with an FL process or at a candidate client to be selected for the FL process is provided. The method comprises at least one of: transmitting, to a server that is associated with the FL process, a fifth message indicating analytics data associated with the client or the candidate client, transmitting, to one or more network nodes, a seventh message indicating data associated with the client or the candidate client, which is used as input data in determining analytics data associated with the client or the candidate client. In some embodiments, the method further comprises any of steps in any of the methods of the sixth aspect.

According to an eighth aspect of the present disclosure, a client is provided. The method comprises: a processor; a memory storing instructions which, when executed by the processor, cause the processor to perform any of the methods of the sixth and/or seventh aspects.

According to a ninth aspect of the present disclosure, a client associated with an FL process is provided. The client comprises at least one of: a receiving module configured to receive, from a server that is associated with the FL process, a first message indicating that the client is unselected by the server for the FL process and/or the FL process is suspended; and a transmitting module configured to transmit, to a server that is associated with the FL process, a second message indicating that the client is quitting the FL process. In some embodiments, the client comprises one or more further modules, each of which may perform any of the steps of any of the methods of the sixth aspect.

According to a tenth aspect of the present disclosure, a client associated with an FL process or a candidate client to be selected for the FL process is provided. The client or the candidate client comprises at least one of: a first transmitting module configured to transmit, to a server that is associated with the FL process, a fifth message indicating analytics data associated with the client or the candidate client; and a second transmitting module configured to transmit, to one or more network nodes, a seventh message indicating data associated with the client or the candidate client, which is used as input data in determining analytics data associated with the client or the candidate client. In some embodiments, the client or the candidate client comprises one or more further modules, each of which may perform any of the steps of any of the methods of the seventh aspect.

According to an eleventh aspect of the present disclosure, a method at a network node is provided. The method comprises: transmitting, to a server that is associated with an FL process, a fifth message indicating analytics data associated with one or more clients associated with the FL process and/or one or more candidate clients to be selected by the server for the FL process.

According to a twelfth aspect of the present disclosure, a network node is provided. The network node comprises: a processor; a memory storing instructions which, when executed by the processor, cause the processor to perform any of the methods of the eleventh aspect.

According to a thirteenth aspect of the present disclosure, a network node is provided. The network node comprises: a transmitting module configured to transmit, to a server that is associated with an FL process, a fifth message indicating analytics data associated with one or more clients associated with the FL process and/or one or more candidate clients to be selected by the server for the FL process. In some embodiments, the network node comprises one or more further modules, each of which may perform any of the steps of any of the methods of the eleventh aspect.

According to a fourteenth aspect of the present disclosure, a computer program comprising instructions is provided. The instructions, when executed by at least one processor, cause the at least one processor to carry out any of the methods of any of the first, second, sixth, seventh, and/or eleventh aspects.

According to a fifteenth aspect of the present disclosure, a carrier containing the computer program of the fourteenth aspect. In some embodiments, the carrier is one of an electronic signal, optical signal, radio signal, or computer readable storage medium.

According to a sixteenth aspect of the present disclosure, a telecommunication system for supporting FL is provided. The telecommunication system comprises: a server of the third, fourth, and/or fifth aspects; and one or more clients of the eighth, ninth, and/or tenth aspects. In some embodiments, the telecommunication system further comprises one or more network nodes of the twelfth and/or thirteenth aspects.

With some embodiments of the present disclosure, FL can be supported in a core network such as a 5GC network. In this way, the maintenance of Federation Learning process and implementation can be completed. In one aspect, Server NWDAF can get the analytics of Client NWDAF(s) through Assist NWDAF(s) and/or from the Client NWDAF(s) directly. Further, in another aspect, the Federated Learning operation can be terminated at Client NWDAF(s) with the consideration of two different methods for ML model information exchanging in the FL execution phase, i.e., reuse the existing service (or its extension) and use new service.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and therefore are not to be considered limiting of its scope, the disclosure will be described with additional specificity and detail through use of the accompanying drawings.

FIG. 1 is a diagram illustrating an exemplary telecommunication network in which support for FL is applicable according to some embodiments of the present disclosure.

FIG. 2 is a diagram illustrating an exemplary procedure for client NWDAF selection in FL preparation phase in which support for FL is applicable according to some embodiments of the present disclosure.

FIG. 3 is a diagram illustrating an exemplary procedure for NWDAF monitoring and re-selection in FL execution phase in which support for FL is applicable according to some embodiments of the present disclosure.

FIG. 4 is a diagram illustrating an exemplary procedure for dynamic discovery of new NWDAF in FL execution phase when the information about the Server NWDAF is known at the new Client NWDAF(s) in which support for FL is applicable according to some embodiments of the present disclosure.

FIG. 5 is a diagram illustrating an exemplary procedure for dynamic discovery of new NWDAF in FL execution phase when the information about the Server NWDAF is unknown at the new Client NWDAF(s) in which support for FL is applicable according to some embodiments of the present disclosure.

FIG. 6 is a diagram illustrating an exemplary system for analytics collection according to some embodiments of the present disclosure.

FIG. 7 is a diagram illustrating an exemplary system for FL process termination at client NWDAF according to some embodiments of the present disclosure.

FIG. 8 is a diagram illustrating exemplary scenarios for analytics collection according to some embodiments of the present disclosure.

FIG. 9 is a diagram illustrating exemplary scenarios for FL process termination at client NWDAF according to some embodiments of the present disclosure.

FIG. 10 is a diagram illustrating exemplary procedures for analytics collection according to some embodiments of the present disclosure.

FIG. 11A and FIG. 11B are diagrams illustrating exemplary procedures for FL process termination at client NWDAF according to some embodiments of the present disclosure.

FIG. 12 is a flow chart of an exemplary method at a server according to an embodiment of the present disclosure.

FIG. 13 is a flow chart of another exemplary method at a server according to another embodiment of the present disclosure.

FIG. 14 is a flow chart of an exemplary method at a client according to an embodiment of the present disclosure.

FIG. 15 is a flow chart of another exemplary method at a client according to another embodiment of the present disclosure.

FIG. 16 is a flow chart of an exemplary method at a network node according to an embodiment of the present disclosure.

FIG. 17 schematically shows an embodiment of an arrangement which may be used in a server, a client, and/or a network node according to an embodiment of the present disclosure.

FIG. 18 is a block diagram of an exemplary server according to an embodiment of the present disclosure.

FIG. 19 is a block diagram of another exemplary server according to another embodiment of the present disclosure.

FIG. 20 is a block diagram of an exemplary client according to an embodiment of the present disclosure.

FIG. 21 is a block diagram of another exemplary client according to another embodiment of the present disclosure.

FIG. 22 is a block diagram of an exemplary network node according to an embodiment of the present disclosure.

### DETAILED DESCRIPTION

Hereinafter, the present disclosure is described with reference to embodiments shown in the attached drawings. However, it is to be understood that those descriptions are just provided for illustrative purpose, rather than limiting the present disclosure. Further, in the following, descriptions of known structures and techniques are omitted so as not to unnecessarily obscure the concept of the present disclosure.

Those skilled in the art will appreciate that the term “exemplary” is used herein to mean “illustrative,” or “serving as an example,” and is not intended to imply that a particular embodiment is preferred over another or that a particular feature is essential. Likewise, the terms “first” and “second,” and similar terms, are used simply to distinguish one particular instance of an item or feature from another, and do not indicate a particular order or arrangement, unless the context clearly indicates otherwise. Further, the term “step,” as used herein, is meant to be synonymous with “operation” or “action.” Any description herein of a sequence of steps does not imply that these operations must be carried out in a particular order, or even that these operations are carried out in any order at all, unless the context or the details of the described operation clearly indicates otherwise.

Conditional language used herein, such as “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment. Also, the term “or” is used in its inclusive sense (and not in its exclusive sense) so that when used, for example, to connect a list of elements, the term “or” means one, some, or all of the elements in the list. Further, the term “each,” as used herein, in addition to having its ordinary meaning, can mean any subset of a set of elements to which the term “each” is applied.

The term “based on” is to be read as “based at least in part on.” The term “one embodiment” and “an embodiment” are to be read as “at least one embodiment.” The term “another embodiment” is to be read as “at least one other embodiment.” Other definitions, explicit and implicit, may be included below. In addition, language such as the phrase “at least one of X, Y and Z,” unless specifically stated otherwise, is to be understood with the context as used in general to convey that an item, term, etc. may be either X, Y, or Z, or a combination thereof.

The terminology used herein is for the purpose of describing particular embodiments only and is not intended to be limitation of example embodiments. As used herein, the singular forms “a”, “an”, and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof. It will be also understood that the terms “connect(s),” “connecting”, “connected”, etc. when used herein, just mean that there is an electrical or communicative connection between two elements and they can be connected either directly or indirectly, unless explicitly stated to the contrary.

Of course, the present disclosure may be carried out in other specific ways than those set forth herein without departing from the scope and essential characteristics of the disclosure. One or more of the specific processes discussed below may be carried out in any electronic device comprising one or more appropriately configured processing circuits, which may in some embodiments be embodied in one or more application-specific integrated circuits (ASICs). In some embodiments, these processing circuits may comprise one or more microprocessors, microcontrollers, and/or digital signal processors programmed with appropriate software and/or firmware to carry out one or more of the operations described above, or variants thereof. In some embodiments, these processing circuits may comprise customized hardware to carry out one or more of the functions described above. The present embodiments are, therefore, to be considered in all respects as illustrative and not restrictive.

Although multiple embodiments of the present disclosure will be illustrated in the accompanying Drawings and described in the following Detailed Description, it should be understood that the disclosure is not limited to the disclosed embodiments, but instead is also capable of numerous rearrangements, modifications, and substitutions without departing from the present disclosure that as will be set forth and defined within the claims.

Further, please note that although the following description of some embodiments of the present disclosure is given in the context of 5G System (5GS), the present disclosure is not limited thereto. In fact, as long as support for FL is involved, the inventive concept of the present disclosure may be applicable to any appropriate communication architecture, for example, to Global System for Mobile Communications (GSM)/General Packet Radio Service (GPRS), Enhanced Data Rates for GSM Evolution (EDGE), Code Division Multiple Access (CDMA), Wideband CDMA (WCDMA), Time Division-Synchronous CDMA (TD-SCDMA), CDMA2000, Worldwide Interoperability for Microwave Access (WiMAX), Wireless Fidelity (Wi-Fi), Universal Terrestrial Radio Access Network (UTRAN), Evolved UTRAN (E-UTRAN), Long Term Evolution (LTE), Evolved Packet System (EPS), etc. Therefore, one skilled in the arts could readily understand that the terms used herein may also refer to their equivalents in any other infrastructure. For example, the term “User Equipment” or “UE” used herein may refer to a mobile device, a mobile terminal, a mobile station, a user device, a user terminal, a wireless device, a wireless terminal, an IoT device, a vehicle, or any other equivalents. For another example, the term “network node” used herein may refer to or comprise a base station, a base transceiver station, an access point, a hot spot, a NodeB (NB), an evolved NodeB (eNB), a gNB, a network element, a network function, or any other equivalents.

Further, following 3GPP documents are incorporated herein by reference in their entireties:
3GPP Technical Specification (TS) 23.288 V18.0.0 (2022-12), Technical Specification, 3rd Generation Partnership Project; Technical Specification Group Services and System Aspects; Architecture enhancements for 5G System (5GS) to support network data analytics services (Release 18));
3GPP TR 23.700-81 V2.0.0 (2022-11), Technical Report, 3rd Generation Partnership Project; Technical Specification Group Services and System Aspects; Study of Enablers for Network Automation for 5G, 5G System (5GS); Phase 3 (Release 18).

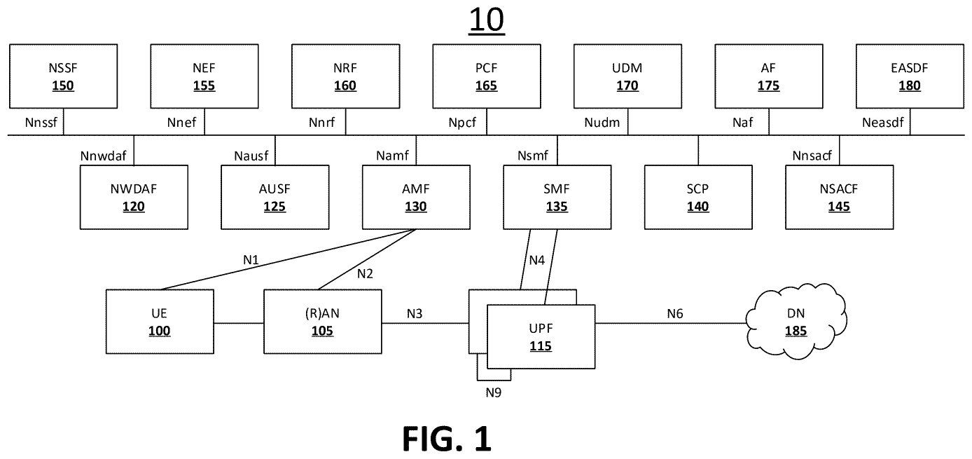

FIG. 1 is a block diagram illustrating an exemplary telecommunication network 10 in which support for FL is applicable according to an embodiment of the present disclosure. Although the telecommunication network 10 is a network defined in the context of 5GS, the present disclosure is not limited thereto.

As shown in FIG. 1, the network 10 may comprise one or more UEs 100 and a (radio) access network ((R)AN) 105 comprising one or more RAN nodes, such as a base station, a Node B, an evolved NodeB (eNB), a gNB, or an Access Network (AN) node which provides the UEs 100 with access to other parts of the network 10. Further, the network 10 may comprise its core network portion comprising (but not limited to) one or more User Plane Functions (UPFs) 115, an NWDAF 120, an Authentication Server Function (AUSF) 125, an Access and Mobility Management Function (AMF) 130, a Session Management Function (SMF) 135, a Service Communication Proxy (SCP) 140, a Network Slice Admission Control Function (NSACF) 145, a Network Slice Selection Function (NSSF) 150, a Network Exposure Function (NEF) 155, a Network Repository Function (NRF) 160, a Policy Control Function (PCF) 165, a Unified Data Management (UDM) 170, an Application Function (AF) 175, and an Edge Application Server Discovery Function (EASDF) 180. As shown in FIG. 1, these entities may communicate with each other via the service-based interfaces, such as, Namf, Nsmf, etc. and/or the reference points, such as, N1, N2, N3, N4, N6, N9, etc.

However, the present disclosure is not limited thereto. In some other embodiments, the network 10 may comprise additional network functions, less network functions, or some variants of the existing network functions shown in FIG. 1. For example, in a network with the 4G EPS architecture, the entities which perform these functions (e.g., Mobility Management Entity (MME)) may be different from those shown in FIG. 1 (e.g., the AMF 120). For another example, in a network with a mixed 4G/5G architecture, some of the entities may be same as those shown in FIG. 1, and others may be different. Further, the functions shown in FIG. 1 are not essential to the embodiments of the present disclosure. In other words, some of them may be missing from some embodiments of the present disclosure.

As shown in FIG. 1, the UPFs 115 are communicatively connected to a Data Network (DN) 185 which may be, or in turn communicatively connected to, the Internet, such that the UE 100 may finally communicate its user plane data with other devices outside the network 10, for example, via the RAN 105 and the UPFs 115.

Some of the network functions shown in FIG. 1 that may be involved in some embodiments of the present disclosure will be described below.

In some embodiments, the NWDAF 120 may include one or more of the following functionalities:
Support data collection from NFs and AFs;
Support data collection from Operations, Administration, and Maintenance (OAM);
NWDAF service registration and metadata exposure to NFs and AFs;
Support analytics information provisioning to NFs and AFs;
Support Machine Learning (ML) model training and provisioning to NWDAFs (containing Analytics logical function).

As mentioned above, the maintenance of FL process among multiple NWDAFs in 5GC has been added into the conclusion (mainly in Principle 5) in clause 8.8 of TR 23.700-81, v2.0.0. The content of the Principle 5 is as follows:
Principle 5: NWDAF containing MTLF as FL server may determine the final list of NWDAF containing MTLF as FL clients via initial FL request to FL clients to determine the availability and compatibility of the FL clients. During the FL procedure, the NWDAF containing MTLF as FL server may trigger reselection, addition or removal of FL clients and may issue a new FL client discovery via NRF, based on local policy or status of FL clients, e.g. load, availability, capability, latency, accuracy, etc. FL clients can join or quit FL operation dynamically in the execution phase.

Solution for maintenance of FL process among multiple NWDAFs in 5GC has been given in TR 23.700-81, 2.0.0 (i.e., Solution #51).

### Solution #51: Selection, Monitoring, and Maintenance of NWDAF(s) for Federated Learning in 5GC

### DESCRIPTION

This solution is proposed to address Key Issue #8: Supporting Federated Learning in 5GC. The study bullets of this Key Issue include:
Study how to coordinate multiple NWDAFs including selection of participant NWDAF instances in the Federated Learning group, e.g. assistance information (if any) to perform the selection, and decision of role for the participant NWDAF.
Study whether and how to perform performance (e.g. network performance and model performance) monitoring of the NWDAF Federated Learning operation.

To address the challenges in the above bullets for supporting Federated Learning in 5GC, this solution focus on the NWDAF(s) selection in Federated Learning preparation phase, NWDAF(s) monitoring and maintenance in Federated Learning execution phase.

A lot of factors influence Client NWDAF(s) selection in Federated Learning preparation phase. For example, the capability of NWDAF(s), the interoperability and availability of Client NWDAF(s) to join in Federated Learning.

In Federated Learning execution phase, due to dynamic changes of federation network, current Client NWDAF(s) may leave or join, the dynamic joining and leaving of Client NWDAF(s) to a Federated Learning multi-round learning/training process in 5GC should be considered. In addition, methods may be applied for Server NWDAF to monitoring the status changes (e.g. changes of capabilities and availability) of Client NWDAF(s).

### Procedures

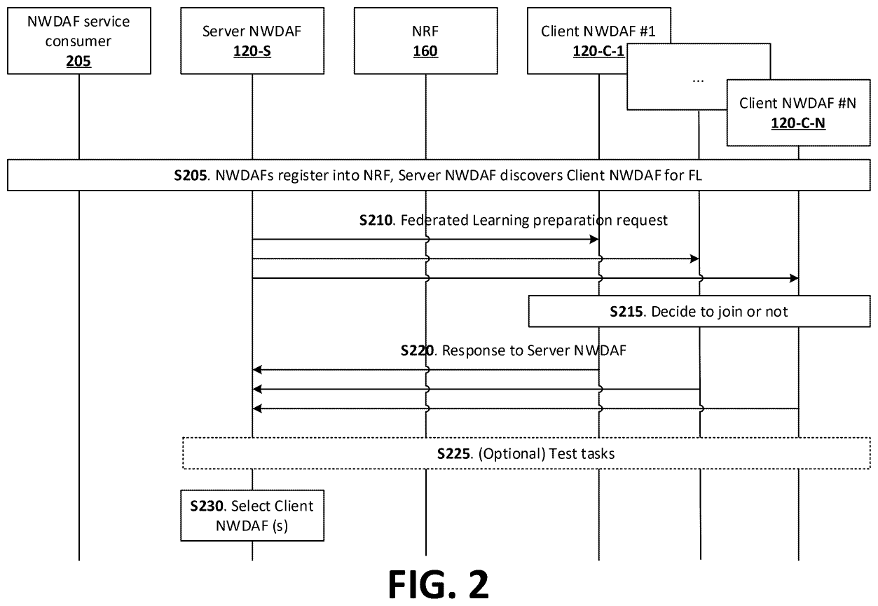

FIG. 2 is a diagram illustrating an exemplary procedure for client NWDAF selection in FL preparation phase in which support for FL is applicable according to some embodiments of the present disclosure.

In Federated Learning preparation phase, Server and (potential) Client NWDAFs (e.g., a Server NWDAF 120-S and one or more Client NWDAFs 120-C-1 through 120-C-N, or collectively 120-C, shown in FIG. 2) are discovered via NRF (e.g., an NRF 160 shown in FIG. 2), and Client NWDAF(s) are selected by the method for handshake pattern. The Client NWDAF(s) selection is based on the availability, capability, etc.

In some embodiments, an exemplary procedure for NWDAFs selection is shown in FIG. 2 and described as follows:

At step S205, NWDAFs (e.g., the Server NWDAF 120-S and/or the Client NWDAFs 120-C-1 through 120-C-N) may register into NRF 160 with Federated Learning capability. In some embodiments, Server NWDAF 120-S may discover Client NWDAFs 120-C based on e.g. Federated Learning capability, Analytics identifier (ID), etc.

At step S210, Server NWDAF 120-S may send Federated Learning preparation request to the Client NWDAF(s) 120-C, for example, by invoking an Nnwdaf_MLPreparation_Request service operation with Interoperability information. In the preparation request, indication of the role for the NWDAF(s), i.e. act as Client NWDAF(s), may be contained.

In some embodiments, the Interoperability information may indicate what abilities (e.g. able to run certain models) are needed for the client NWDAF 120-C to support this FL procedure, e.g. if the server NWDAF 120-S and the client NWDAF 120-C can share model and how to share model.

At step S215, Client NWDAF(s) 120-C may decide whether to join the Federated Learning process based on its availability, capability and Interoperability information.

At step S220, Client NWDAF(s) 120-C may send the response to server NWDAF 120-S indicating if it wants to join the FL procedure.

At step S225, the Server NWDAF 120-S may send test tasks to the Client NWDAF(s) 120-C that want to join the FL procedure. The Client NWDAF(s) 120-C may run the test tasks and send the results to the Server NWDAF 120-S.

In some embodiments, the test tasks may be micro computation or training tasks, the requirement for completing the micro tasks is the same as or is similar to the main tasks. In some embodiments, the test task could be a small task to let the client NWDAF 120-C collect local data and send the local model weights back to the server 120-S; or some test to make sure that the server and client NWDAFs 120-S and 120-C can communicate if they use the same FL framework or library.

At step S230, Server NWDAF 120-S may select the Client NWDAF(s) 120-C, the result of the test tasks may be taken into account by the Server NWDAF 120-S for the selection of Client NWDAF(s) 120-C.

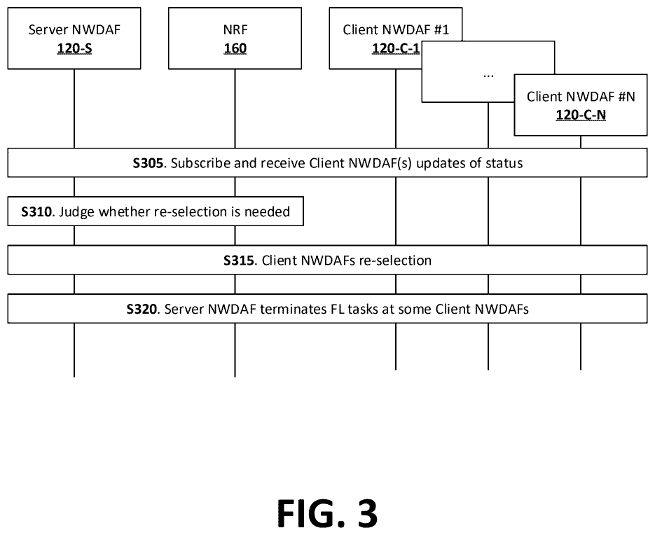

FIG. 3 is a diagram illustrating an exemplary procedure for NWDAF monitoring and re-selection in FL execution phase in which support for FL is applicable according to some embodiments of the present disclosure.

In Federated Learning execution phase, Server NWDAF (a Server NWDAF 120-S) monitors the status changes of Client NWDAF(s) (e.g., one or more Client NWDAFs 120-C-1 through 120-C-N, or collectively 120-C, shown in FIG. 3). In some embodiments, Client NWDAF(s) 120-C may be re-selected based on the updated status, availability, and/or capability, etc. of the Client NWDAF(s) 120-C for the FL tasks.

In some embodiments, an exemplary procedure for monitoring and re-selection of Client NWDAF(s) 120-C is shown in FIG. 3 and described as follows:

At step S305, Server NWDAF 120-S, which monitors the status of Client NWDAF(s) 120-C during the Federated Learning execution process, may receive the updated status of the Client NWDAF(s) 120-C.

In some embodiments, Server NWDAF 120-S may perform monitoring and obtain the updated status of Client NWDAF(s) 120-C directly and/or via NRF 160.

In some embodiments, the status of client NWDAF 120-C could be the NF load, NF availability, its capability changes, e.g. it does not support FL anymore.

At step S310, Server NWDAF 120-S may check Client NWDAF(s) status based on the received information, judge whether re-selection of Client NWDAF(s) 120-C for the next round(s) of Federated Learning is needed. In some embodiments, the judgment may be based on the updated status of the Client NWDAF(s) 120-C, including the availability, capability, etc.

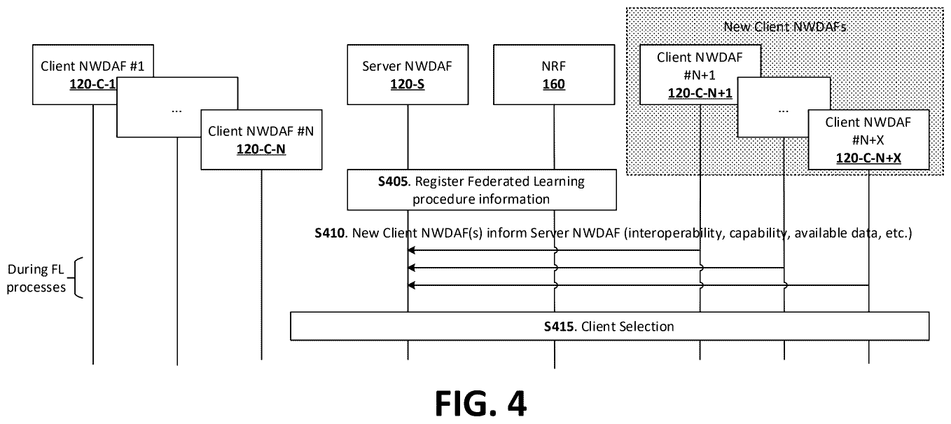

At step S315, [If re-selection is needed as judged in step S310] Server NWDAF 120-S may re-select Client NWDAF(s) 120-C as steps S210 to S230 in FIG. 2. In some embodiments, the procedure for discovery of new Client NWDAF(s) 120-C in Federated Learning execution phase is described with reference to FIG. 4.

At step S320, Client NWDAF(s) 120-C may terminate operations for the Federated Learning if it receives termination request from the Server NWDAF 120-S.

There are two possible cases for Server NWDAF to get the information of the new Client NWDAF(s), i.e. from the new Client NWDAF(s) directly or via NRF.

In some embodiments, Client NWDAFs #1 120-C-1 to #N 120-C-N may be selected by Server NWDAF 120-S for participating the current round of Federated Learning. In some embodiments, Client NWDAFs #N+1 120-C-N+1 to #N+X 120-C-N+X, which are the new ones, have the capability to join in the next rounds of training processes.

FIG. 4 is a diagram illustrating an exemplary procedure for dynamic discovery of new NWDAF in FL execution phase when the information about the Server NWDAF is known at the new Client NWDAF(s) in which support for FL is applicable according to some embodiments of the present disclosure. In some embodiments, new Client NWDAF(s) (e.g., Client NWDAFs #N+1 120-C-N+1 to #N+X 120-C-N+X), which are available and/or have the capability to join in the Federated Learning processes, know the information about the Server NWDAF 120-S and inform Server NWDAF 120-S directly.

In some embodiments, the procedure is shown in FIG. 4 and described as follows:

At step S405, Server NWDAF 120-S may register into NRF 160 about the Federated Learning procedure with the following parameters:
Federated Learning (FL) Correlation ID.
Analytics ID.

In some embodiments, FL Correlation ID may be used to identify a specific FL procedure. For example, a Server NWDAF or a Client NWDAF can join different FL procedures at the same time, then when they receive messages or data from other NWDAF, they have to know the message or data is for which FL procedure.

In some embodiments, when a server NWDAF starts a FL procedure, it may register the FL procedure in the NRF with FL Correlation ID, Analytics ID. When later a client NWDAF wants to join a FL dynamically, e.g. it wants to update its local model using global information, it will query NRF if there is an ongoing FL for the analytics ID. Then NRF will provide the server NWDAF ID and FL Correlation ID to the client NWDAF, then the client NWDAF can contact the server NWDAF to join the FL procedure. With the FL correlation ID, the server NWDAF knows which FL procedure the client NWDAF wants to join and which model it should provide to the client.

At step S410, if the information about the Server NWDAF 120-S and the corresponding FL procedure is known via NRF 160, new Client NWDAF(s) 120-C-N+1 through 120-C-N+X may inform Server NWDAF 120-S, by invoking an Nnwdaf_MLPreparation_Request service operation, their interoperability and availability.

At step S415, before starting next round of training, Server NWDAF 120-S may select Client NWDAF(s) from NWDAFs #1 120-C-1 to #N+X 120-C-N+X based on the updated information of the Client NWDAF(s) 120-C. In some embodiments, the procedure may be the same as steps S210 through S230 in FIG. 2.

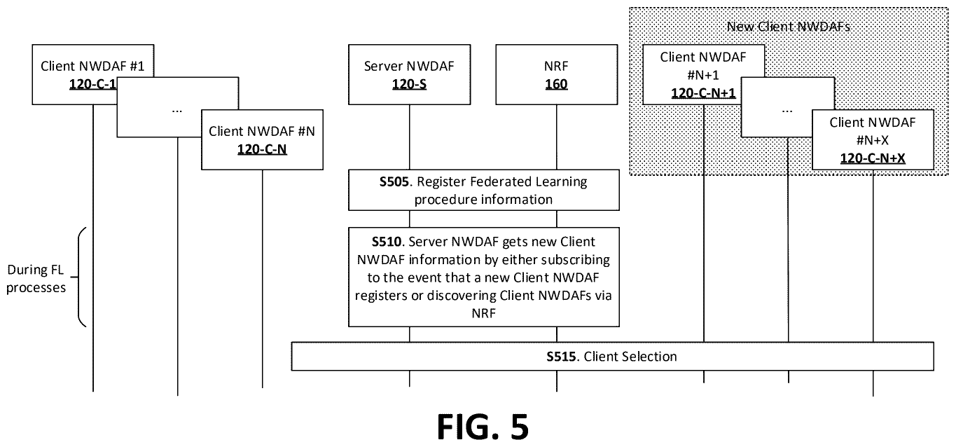

FIG. 5 is a diagram illustrating an exemplary procedure for dynamic discovery of new NWDAF in FL execution phase when the information about the Server NWDAF is unknown at the new Client NWDAF(s) in which support for FL is applicable according to some embodiments of the present disclosure. In some embodiments, Client NWDAFs #1 120-C-1 to #N 120-C-N may be selected by Server NWDAF 120-S for participating the current round of Federated Learning. In some embodiments, Client NWDAFs #N+1 120-C-N+1 to #N+X 120-C-N+X, which are the new ones, may have the capability to join in the next rounds of training processes.

In some embodiments, the procedure is shown in FIG. 5 and described as follows:

Similar to step S405, at step S505, Server NWDAF 120-S may register into NRF 160 about the Federated Learning procedure with the following parameters:
Federated Learning (FL) Correlation ID.
Analytics ID.

At step S510, the Server NWDAF 120-S may get new Client NWDAF information by either subscribing to the event that a new Client NWDAF registers or discovering Client NWDAFs via NRF 160.

Similar to step S415, at step S515, before starting next round of training, Server NWDAF 120-S may select Client NWDAF(s) from NWDAFs #1 120-C-1 to #N+X 120-C-N+X based on the updated information of the Client NWDAF(s) 120-C. In some embodiments, the procedure may be the same as steps S210 through S230 in FIG. 2.

In some embodiments, Server NWDAF 120-S may get the information of the new Client NWDAF(s) dynamically via NRF 160 by either subscribing to the event that a new Client NWDAF registers or discovering NRF 160 when it needs to reselect Client NWDAFs. However, details on how Server NWDAF 120-S gets the analytics of Client NWDAF(s) (e.g., NF load, etc.) 120-C and how to terminate the Federated Learning operation at Client NWDAF(s) 120-C are not given in Solution #51.

As mentioned above, the maintenance of FL process among multiple NWDAFs in 5GC has been added into the conclusion (mainly in Principle 5) in clause 8.8 of TR 23.700-81:
Principle 5: NWDAF containing MTLF as FL server may determine the final list of NWDAF containing MTLF as FL clients via initial FL request to FL clients to determine the availability and compatibility of the FL clients. During the FL procedure, the NWDAF containing MTLF as FL server may trigger reselection, addition or removal of FL clients and may issue a new FL client discovery via NRF, based on local policy or status of FL clients, e.g. load, availability, capability, latency, accuracy, etc. FL clients can join or quit FL operation dynamically in the execution phase.

However, how Server NWDAF gets the analytics of Client NWDAF(s) (e.g., NF load, etc.) and how to terminate the Federated Learning operation at Client NWDAF(s) are still unclear for the maintenance of FL process and implementation.

In some embodiments of the present disclosure, it is proposed to complete the maintenance of FL process and implementation. In some embodiments, procedures for Server NWDAF to get the analytics of Client NWDAF(s) and for terminating the Federated Learning operation at Client NWDAF(s) are given.

In some embodiments, for Server NWDAF to get the analytics of Client NWDAF(s), e.g., NF load, etc., the following situations may be considered:
Server NWDAF subscribes to some other NWDAF(s) (referred it as “Assist NWDAF(s)”) for the analytics of the Client NWDAF(s). In some embodiments, the Assist NWDAF(s) may notify the Server NWDAF the analytics results.
Server NWDAF subscribes to the Client NWDAF(s) for analytics. The Client NWDAF(s) may perform analyzing on itself and notify the Server NWDAF the analytics results.

In some embodiments, the analytics could be sent in notifications to Server NWDAF(s) periodically or dynamically when some pre-determined status is achieved.

In some embodiments, for terminating the Federated Learning operation at Client NWDAF(s), two possible situations may be considered:
The Client NWDAF(s) quits the Federate Learning process;
Server NWDAF removes the Client NWDAF(s) from the FL process.

In some embodiments, for both the above two procedures, two methods for ML model information exchanging between the Server NWDAF and the Client NWDAF(s) in the FL execution phase may be considered, respectively:
Reuse the existing service (or its extension), e.g., Nnwdaf_MLModelProvision given in TS 23.288, v18.0,0, for ML model information exchanging between the Server NWDAF and the Client NWDAF(s).
Use new service for ML model information exchanging between the Server NWDAF and the Client NWDAF(s).

In some embodiments, it is proposed to complete the maintenance of Federation Learning process and implementation. In some embodiments, procedures for Server NWDAF to get the analytics of Client NWDAF(s) through Assist NWDAF(s) and from the Client NWDAF(s) directly are given, respectively. In some embodiments, procedures for terminating the Federated Learning operation at Client NWDAF(s) are given with the consideration of two different methods for ML model information exchanging in the FL execution phase. In some embodiments, the two methods for ML model information exchange include:
Reuse the existing service (or its extension), e.g., Nnwdaf_MLModelProvision, for ML model information exchanging between the Server NWDAF and the Client NWDAF(s).
In some embodiments, use new service for ML model information exchanging between the Server NWDAF and the Client NWDAF(s).

The maintenance of Federated Learning process has been concluded in TR 23.700-81 with some places unclear, for example, how Server NWDAF gets the analytics of Client NWDAF(s) and how to terminate the Federated Learning operation at Client NWDAF(s). With some embodiments of the present disclosure, it is proposed to complete the maintenance of Federation Learning process and implementation. Procedures for Server NWDAF to get the analytics of Client NWDAF(s) through Assist NWDAF(s) and from the Client NWDAF(s) directly are given, respectively. With some embodiments of the present disclosure, procedures for terminating the Federated Learning operation at Client NWDAF(s) are given with the consideration of two different methods for ML model information exchanging in the FL execution phase, i.e., reuse the existing service (or its extension) and use new service.

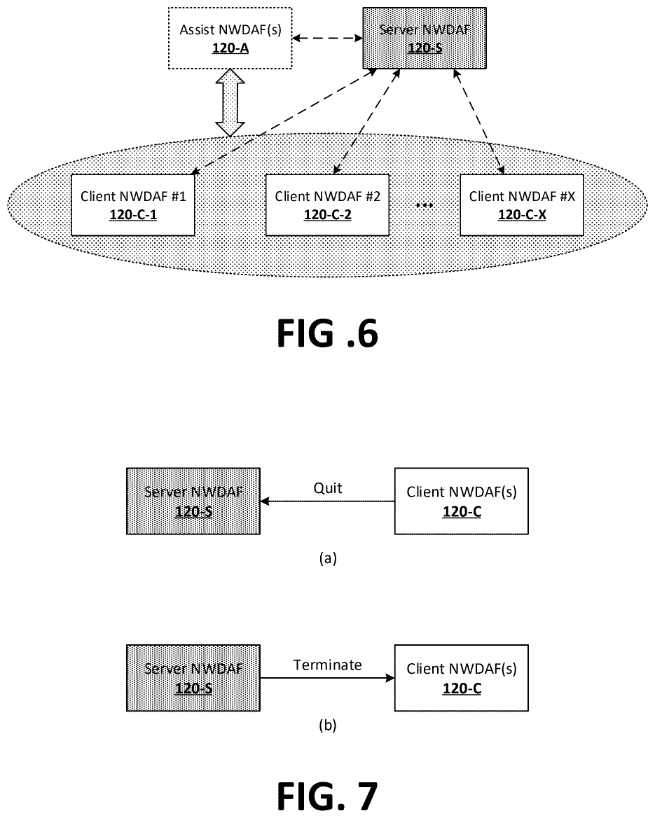

FIG. 6 is a diagram illustrating an exemplary system for analytics collection according to some embodiments of the present disclosure. FIG. 6 illustrates an exemplary system for Server NWDAF 120-S to get the analytics of Client NWDAF(s) 120-C through Assist NWDAF(s) 120-A.

As shown in FIG. 6, Server NWDAF 120-S may subscribe to Assist NWDAF(s) 120-A for analytics on Client NWDAF(s) 120-C, e.g., NF load, etc. Assist NWDAF(s) 120-A may perform analysis on the Client NWDAF(s) 120-C and notify to the Server NWDAF 120-S the analytics periodically or dynamically when some pre-determined status is achieved.

Alternatively, Server NWDAF 120-S may subscribe to the Client NWDAF(s) 120-C for analytics, and the Client NWDAF(s) 120-C may perform analysis on itself and notify to the Server NWDAF 120-S the analytics periodically or dynamically when some pre-determined status is achieved.

In some embodiments, the FL process may be ongoing between the Server NWDAF 120-S and the Client NWDAF(s) 120-C, or the Client NWDAF(s) 120-C may be new candidate Client NWDAF(s) for the Server NWDAF 120-S to select for a FL process.

FIG. 7 is a diagram illustrating an exemplary system for FL process termination at client NWDAF according to some embodiments of the present disclosure. FIG. 7 illustrates an exemplary system for terminating the Federated Learning operation at Client NWDAF(s) 120-C in FL execution phase.

In (a) of FIG. 7, Client NWDAF(s) 120-C may quit the Federated Learning operation in FL execution phase. In (b) of FIG. 7, Server NWDAF 120-S may terminate the Federated Learning operation at the Client NWDAF(s) 120-C which will be removed from the FL process.

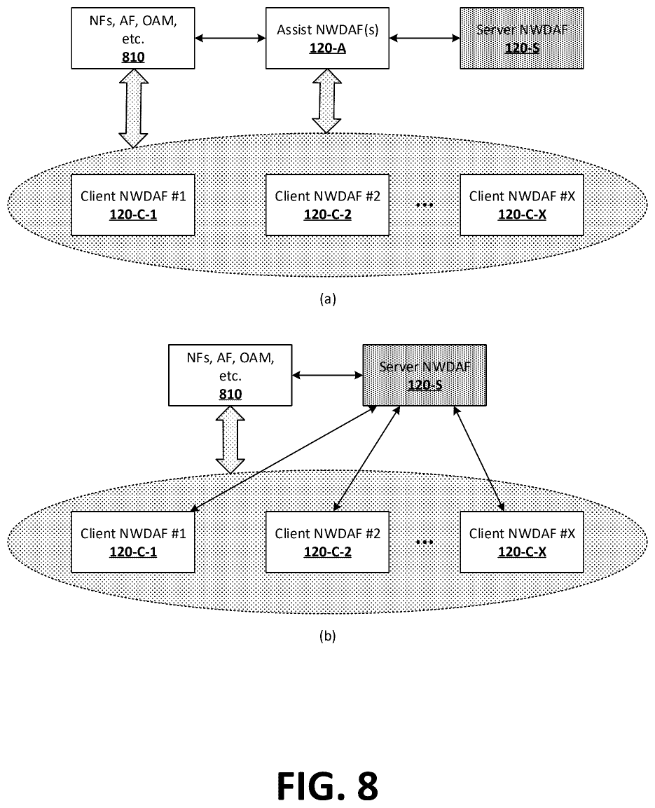

FIG. 8 is a diagram illustrating exemplary scenarios for analytics collection according to some embodiments of the present disclosure. FIG. 8 shows an exemplary system for Server NWDAF 120-S to get the analytics of Client NWDAF(s) 120-C through Assist NWDAF(s) 120-A (e.g., as shown in (a)), and from the Client NWDAF(s) 120-C directly (e.g., as shown in (b)).

As shown in (a) of FIG. 8, Server NWDAF 120-S may subscribe to Assist NWDAF(s) 120-A for analytics on Client NWDAF(s) 120-C, e.g., Analytics ID=“NF load information”, etc. Assist NWDAF(s) 120-A may collect data from the other NFs in 5GC (maybe also the Client NWDAF(s) 120-C), AF and/or OAM 810, perform analysis for the Analytics ID of the Client NWDAF(s) 120-C based on the collected data, and notify to the Server NWDAF 120-S the analytics results periodically or dynamically (e.g., when some pre-determined status is achieved).

As shown in (b) of FIG. 8, Server NWDAF 120-S may subscribe to the Client NWDAF(s) 120-C for self-analytics, e.g., Analytics ID=“NF load information”, etc. The Client NWDAF(s) 120-C may collect data from the other NFs in 5GC, AF and/or OAM 810, perform analysis for the Analytics ID of itself based on the collected data and maybe also its own data, and notify to the Server NWDAF 120-S the analytics results periodically or dynamically (e.g., when some pre-determined status is achieved).

In some embodiments, the FL process may be ongoing between the Server NWDAF 120-S and the Client NWDAF(s) 120-C, or the Client NWDAF(s) 120-C may be new candidate Client NWDAF(s) for the Server NWDAF 120-S to select for a FL process.

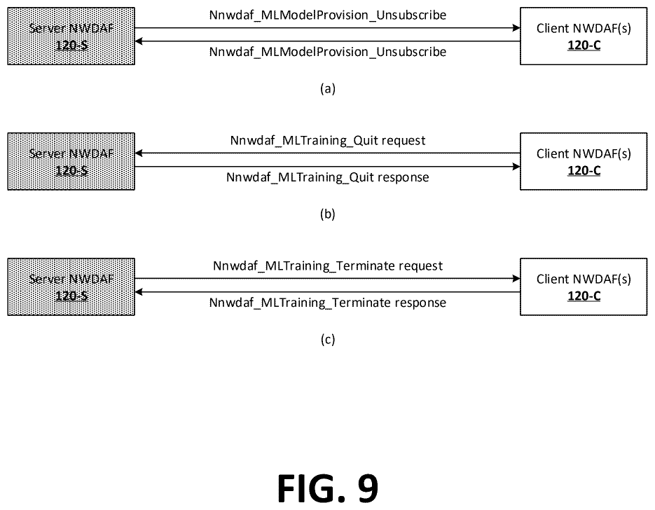

FIG. 9 is a diagram illustrating exemplary scenarios for FL process termination at client NWDAF according to some embodiments of the present disclosure. FIG. 9 shows an exemplary system for terminating the Federated Learning operation at Client NWDAF(s) 120-C in FL execution phase by reusing the existing service (or its extension) (as shown in (a)), using new service for Client NWDAF(s) 120-C to quit (as shown in (b)), and using new service for Server NWDAF 120-S to terminate (as shown in (c)).

As shown in (a) of FIG. 9, Server NWDAF 120-S and Client NWDAF(s) 120-C may unsubscribe to each other for ML model information exchanging in FL execution phase by invoking Nnwdaf_MLModelProvision_Unsubscribe service operation. After receiving the unsubscribe request, the Server NWDAF 120-S may stop sharing ML model information with the Client NWDAF(s) 120-C, the Client NWDAF(s) 120-C may terminate the corresponding Federated Learning operation and stop sharing local ML model information with the Server NWDAF 120-S.

As shown in (b) of FIG. 9, Client NWDAF(s) 120-C may send Nnwdaf_MLTraining_Quit request to the Server NWDAF 120-S to quit the Federated Learning process. After receiving the quit request from the Client NWDAF(s) 120-C, the Server NWDAF 120-S may stop sharing ML model information with the Client NWDAF(s) 120-C and send Nnwdaf_MLTraining_Quit response to the Client NWDAF(s) 120-C. After receiving the quit response, the Client NWDAF(s) 120-C may terminate the corresponding Federated Learning operation and stop sharing local ML model information with the Server NWDAF 120-S.

As shown in (c) of FIG. 9, Server NWDAF 120-S may send Nnwdaf_MLTraining_Terminate request to the Client NWDAF(s) 120-C to terminate the Federated Learning operation at Client NWDAF(s) 120-C and stop sharing ML model information to the Client NWDAF(s) 120-C. After receiving the termination request from the Server NWDAF 120-S, the Client NWDAF(s) 120-C may terminate the corresponding Federated Learning operation, stop sharing local ML model information with the Server NWDAF 120-S, and send Nnwdaf_MLTraning_Terminate response to the Server NWDAF 120-S.

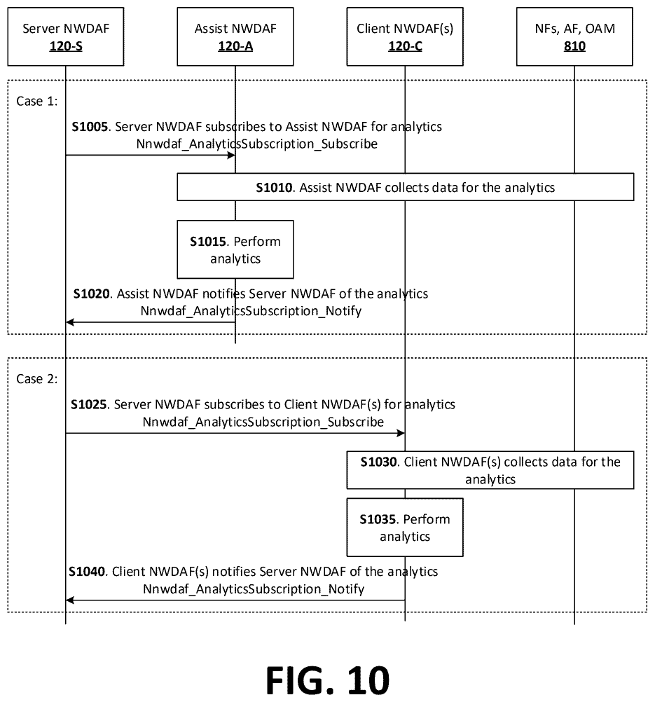

FIG. 10 is a diagram illustrating exemplary procedures for analytics collection according to some embodiments of the present disclosure. FIG. 10 illustrates two exemplary procedures for Server NWDAF 120-S to get the analytics of Client NWDAF(s) 120-C in Federated Learning execution phase, which corresponds to the following two cases:
Case 1: Server NWDAF 120-S gets analytics of Client NWDAF(s) 120-C from Assist NWDAF(s) 120-A;
Case 2: Server NWDAF 120-S gets analytics of Client NWDAF(s) 120-C from the Client NWDAF(s) 120-C.

The corresponding procedures are described as follows.

### Case 1:

At step S1005, Server NWDAF 120-S may subscribe to Assist NWDAF(s) 120-A for the analytics of Client NWDAF(s) 120-C by invoking

Nnwdaf_AnalyticsSubscription_Subscribe service operation (Analytics ID=“NF load information”, etc.). In some embodiments, an exemplary procedure for setting up the subscription is provided by clauses 6.1.1 and 7.2.2 of TS 23.288, V18.0.0 (about Nnwdaf_AnalyticsSubscription_Subscribe).

At step S1010, the Assist NWDAF(s) 120-A may collect data for the analytics from the other NFS, AF, OAM 810, etc., and may also collect data from the Client NWDAF(s) 120-C. In some embodiments, exemplary information about data collection for analytics is provided in clauses 6.3 to 6.16 of TS 23.288, V18.0.0 (about Analytics ID and inputs).

At step S1015, after data collection, the Assist NWDAF(s) 120-A may perform analytics on the Analytics ID, e.g., NF load information, for the Client NWDAF(s) 120-C based on the collected data.

At step S1020, the Assist NWDAF(s) 120-A may notify the Server NWDAF 120-S the analytics results by invoking Nnwdaf_AnalyticsSubscription_Notify service operation periodically or dynamically (e.g., when some pre-determined status is achieved). In some embodiments, an exemplary procedure for sending notification is provided in clauses 6.1.1 and 7.2.4 of TS 23.288, V18.0.0 (about Nnwdaf_AnalyticsSubscription_Notify). In some embodiments, exemplary information about outputs is provided in clauses 6.3 to 6.16 of TS 23.288, V18.0.0 (about Analytics ID and outputs).

### Case 2:

At step S1025, Server NWDAF 120-S may subscribe to (all or some of the) Client NWDAF(s) 120-C for the analytics of Client NWDAF(s) 120-C by invoking Nnwdaf_AnalyticsSubscription_Subscribe service operation (Analytics ID=“NF load information”, etc.). In some embodiments, an exemplary procedure for setting up the subscription is provided in clauses 6.1.1 and 7.2.2 of TS 23.288, V18.0.0 (about Nnwdaf_AnalyticsSubscription_Subscribe).

At step S1030, the Client NWDAF(s) 120-C may collect data for the analytics from the other NFs, AF, OAM 810, etc. In some embodiments, exemplary information about data collection for analytics is provided in clauses 6.3 to 6.16 of TS 23.288, V18.0.0 (about Analytics ID and inputs).

At step S1035, after data collection, the Client NWDAF(s) 120-C may perform analytics on the Analytics ID, e.g., NF load information, for itself based on the collected data and may also its own data.

At step S1040, the Client NWDAF(s) 120-C may notify the Server NWDAF 120-S the analytics results by invoking Nnwdaf_AnalyticsSubscription_Notify service operation periodically or dynamically (e.g., when some pre-determined status is achieved). In some embodiments, an exemplary procedure for sending notification is provided in clauses 6.1.1 and 7.2.4 of TS 23.288, V18.0.0 (about Nnwdaf_AnalyticsSubscription_Notify). In some embodiments, exemplary information about outputs is provided in clauses 6.3 to 6.16 of TS 23.288, V18.0.0 (about Analytics ID and outputs).

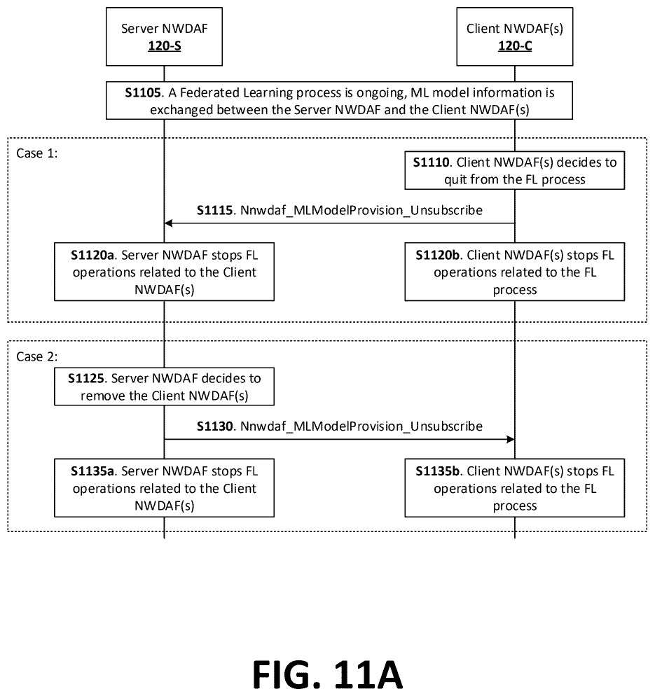

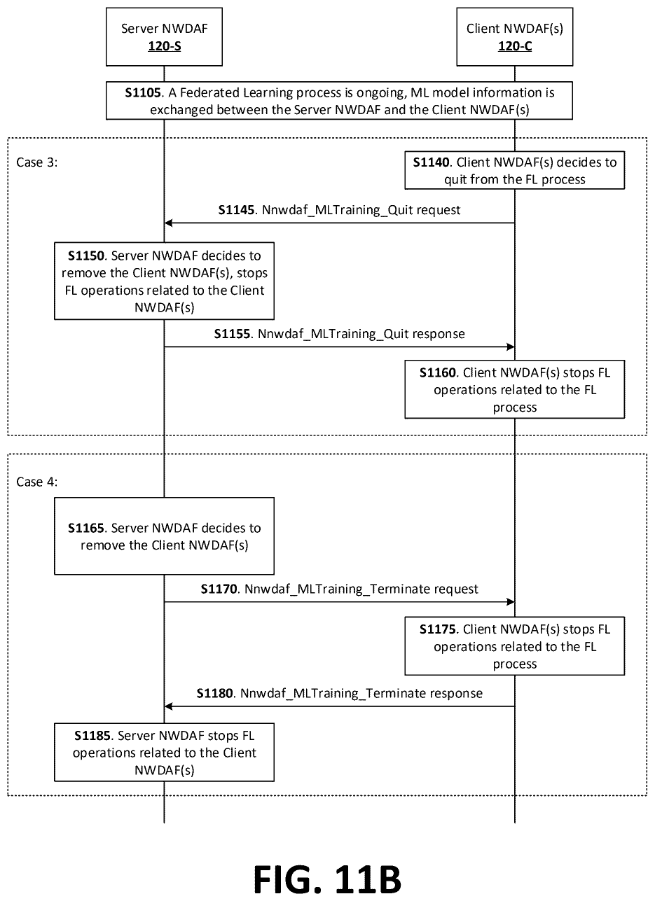

FIG. 11A and FIG. 11B are diagrams illustrating exemplary procedures for FL process termination at client NWDAF according to some embodiments of the present disclosure. FIG. 11A and FIG. 11B illustrate procedures for terminating Federated Learning operation at Client NWDAF(s) 120-C in FL execution phase, which correspond to following four cases:
Case 1: Existing service (or its extension) is used for the ML model information exchanging, (one or more) Client NWDAF(s) 120-C decides to quit from the FL process;
Case 2: Existing service (or its extension) is used for the ML model information exchanging, Server NWDAF 120-S decides to remove (one or more) Client NWDAF(s) 120-C from the FL process;
Case 3: A new service is used for the ML model information exchanging, (one or more) Client NWDAF(s) 120-C decides to quit from the FL process;
Case 4: A new service is used for the ML model information exchanging, Server NWDAF 120-S decides to remove (one or more) Client NWDAF(s) 120-C from the FL process.

The corresponding procedures are described as follows.

As shown in both of FIG. 11A and FIG. 11B, at step S1105, a Federated Learning process is ongoing, and the ML model information is exchanged between the Server NWDAF 120-S and the Client NWDAF(s) 120-C in the FL execution phase by using either existing service (or its extension) (e.g., Nnwdaf_MLModelProvision service) or a new service (e.g., Nnwdaf_MLTraining service or any other possible new services). The rest steps for Cases 1-4 are described as follows.

### Case 1 in FIG. 11A:

At step S1110, the Client NWDAF(s) 120-C may decide to quit from the FL process.

At step S1115, the Client NWDAF(s) 120-C may unsubscribes to the Server NWDAF 120-S for the ML model information exchanging by invoking Nnwdaf_MLModelProvision_Unsubscribe service operation with FL Correlation ID, cause code (e.g., Client NWDAF(s) 120-C quits the FL process with detail reasons (e.g., availability change, capability change, etc.), etc.).

In some embodiments, the Client NWDAF(s) 120-C may transmit an Nnwdaf_MLModelProvision_Unsubscribe request message to the Server NWDAF 120-S, and the server NWDAF 120-S may respond with an Nnwdaf_MLModelProvision_Unsubscribe response message. In some other embodiments, the Client NWDAF(s) 120-C may transmit an Nnwdaf_MLModelProvision_Unsubscribe request message to the Server NWDAF 120-S, and the server NWDAF 120-S may respond with another Nnwdaf_MLModelProvision_Unsubscribe request message, rather than an Nnwdaf_MLModelProvision_Unsubscribe response message. Either way, the Client and Server NWDAFs can reach an agreement on the termination of the FL process at the Client NWDAF(s).

In some embodiments, if Client NWDAF(s) 120-C quits, the context of this FL process at the Client NWDAF(s) 120-C will be cleared.

In some embodiments, an exemplary description of unsubscribe is provided in clauses 6.2A.1 and 7.5.3 of TS 23.288 V18.0.0 (about Nnwdaf_MLModelProvision_Unsubscribe).

At step S1120, the Server NWDAF 120-S and the Client NWDAF(s) 120-C may stop FL operations related to each other.

At step 1120a, the Server NWDAF 120-S may stop the Federated Learning operations related to the Client NWDAF(s) 120-C for the FL process.

At step 1120b, the Client NWDAF(s) 120-C may stop Federated Learning operations related to the FL process.

### Case 2 in FIG. 11A:

At step S1125, the Server NWDAF 120-S may decide to remove the Client NWDAF(s) 120-C from the FL process.

In some embodiments, the Client NWDAF(s) 120-C may decide to quit from the FL process as well.

At step S1130, the Server NWDAF 120-S may unsubscribe to the Client NWDAF(s) 120-C for the ML model information exchanging by invoking Nnwdaf_MLModelProvision_Unsubscribe service operation with FL Correlation ID, cause code (e.g., Client NWDAF(s) 120-C is unselected by the Server NWDAF 120-S for the FL process, or the FL process is suspended, etc.).

In some embodiments, the Server NWDAF 120-S may transmit an Nnwdaf_MLModelProvision_Unsubscribe request message to the Client NWDAF 120-C, and the Client NWDAF(s) 120-C may respond with an Nnwdaf_MLModelProvision_Unsubscribe response message. In some other embodiments, the Server NWDAF 120-S may transmit an Nnwdaf_MLModelProvision_Unsubscribe request message to the Client NWDAF(s) 120-C, and the server NWDAF 120-S may respond with another Nnwdaf_MLModelProvision_Unsubscribe request message, rather than an Nnwdaf_MLModelProvision_Unsubscribe response message. Either way, the Client and Server NWDAFs can reach an agreement on the termination of the FL process at the Client NWDAF(s).

In some embodiments, if Client NWDAF(s) 120-C is unselected from the FL process, the context of this FL process at the Client NWDAF(s) 120-C will be cleared.

In some embodiments, an exemplary description of unsubscribe is provided in clauses 6.2A.1 and 7.5.3 of TS 23.288 V18.0.0, about Nnwdaf_MLModelProvision_Unsubscribe).

At step S1135, the Server NWDAF 120-S and the Client NWDAF(s) 120-C may stop FL operations related to each other.

At step S1135a, the Server NWDAF 120-S may stop the Federated Learning operations related to the Client NWDAF(s) 120-C for the FL process.

At step S1135b, the Client NWDAF(s) 120-C may stop Federated Learning operations related to the FL process.

### Case 3 in FIG. 11B:

At step S1140, the Client NWDAF(s) 120-C may decide to quit the Federated Learning process.

At step S1145, the Client NWDAF(s) 120-C may send request to the Server NWDAF 120-S for quitting the FL process by invoking e.g., Nnwdaf_MLTraining_Quit request service operation (or use any other possible new services for ML model information exchanging in FL execution phase) with FL Correlation ID, cause code (e.g., availability change, capability change, etc.).

At step S1150, the Server NWDAF 120-S may decide to remove the Client NWDAF(s) 120-C from the FL process, stop FL operations related to the Client NWDAF(s) 120-C.

At step S1155, the Server NWDAF 120-S may respond to the Client NWDAF(s) 120-C for the quit request by invoking Nnwdaf_MLTraining_Quit response service operation (or use any other possible new services for ML model information exchanging in FL execution phase) with parameters (e.g., time for the Client NWDAF(s) 120-C to quit, etc.).

At step S1160, the Client NWDAF(s) 120-C may stop the Federated Learning operations and clear the context related to the FL process.

### Case 4 in FIG. 11B:

At step S1165, the Server NWDAF 120-S may decide to remove the Client NWDAF(s) 120-C from the FL process.

At step S1170, the Server NWDAF 120-S may send request to the Client NWDAF(s) 120-C for terminating the FL operation of the FL process at the Client NWDAF(s) 120-C by invoking e.g., Nnwdaf_MLTraining_Terminate request service operation (or use any other possible new services for ML model information exchanging in FL execution phase) with FL Correlation ID, cause code (e.g., Client NWDAF(s) 120-C is unselected by the Server NWDAF 120-S for the FL process, or the FL process is suspended, etc.).

At step S1175, the Client NWDAF(s) 120-C may stop the Federated Learning operations related to the FL process.

In some embodiments, if Client NWDAF(s) 120-C is unselected the from FL process, the context of this FL process at the Client NWDAF(s) 120-C will be cleared.

At step S1180, the Client NWDAF(s) 120-C may respond to the Server NWDAF 120-S for the terminate request by invoking Nnwdaf_MLTraining_Terminate response service operation (or use any other possible new services for ML model information exchanging in FL execution phase).

At step S1185, the Server NWDAF 120-S may stop the Federated Learning operations related to the Client NWDAF(s) 120-C for the FL process.

With some embodiments of the present disclosure described above, FL can be supported in a core network such as a 5GC network. In this way, the maintenance of Federation Learning process and implementation can be completed. Procedures for Server NWDAF to get the analytics of Client NWDAF(s) through Assist NWDAF(s) and from the Client NWDAF(s) directly are provided, respectively. Further, procedures for terminating the Federated Learning operation at Client NWDAF(s) are provided with the consideration of two different methods for ML model information exchanging in the FL execution phase, i.e., reuse the existing service (or its extension) and use new service.

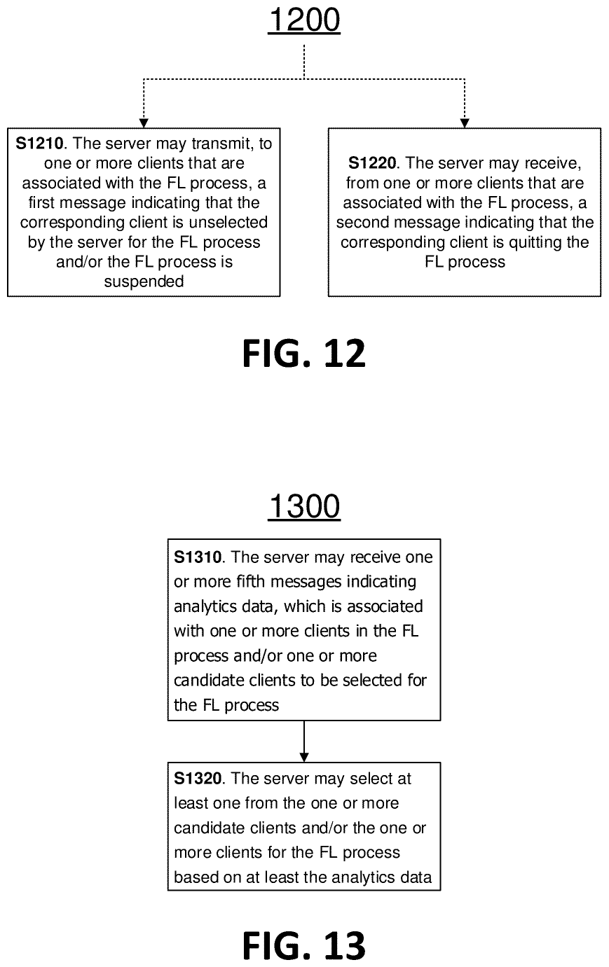

FIG. 12 is a flow chart of an exemplary method 1200 at a server associated with an FL process according to an embodiment of the present disclosure. The method 1200 may be performed at a Server NWDAF (e.g., the Server NWDAF 120-S shown in FIG. 6). The method 1200 may comprise at least one of steps S1210 and S1220. However, the present disclosure is not limited thereto. In some other embodiments, the method 1200 may comprise more steps, less steps, different steps, or any combination thereof. Further the steps of the method 1200 may be performed in a different order than that described herein. Further, in some embodiments, a step in the method 1200 may be split into multiple sub-steps and performed by different entities, and/or multiple steps in the method 1200 may be combined into a single step.

The method 1200 may begin with at least one of steps S1210 and S1220.

At step S1210, the server may transmit, to one or more clients that are associated with the FL process, a first message indicating that the corresponding client is unselected by the server for the FL process and/or the FL process is suspended.

At step S1220, the server may receive, from one or more clients that are associated with the FL process, a second message indicating that the corresponding client is quitting the FL process.

In some embodiments, at least one of the first message and the second message may further indicate at least one of: an FL Correlation ID; and a cause code. In some embodiments, the cause code may indicate at least one of: the corresponding client is unselected by the server for the FL process when the cause code is indicated by the first message; the FL process is suspended when the cause code is indicated by the first message; an availability change associated with the corresponding client when the cause code is indicated by the corresponding second message; and a capability change associated with the corresponding client when the cause code is indicated by the corresponding second message.

In some embodiments, the method 1200 may further comprise at least one of: receiving, from at least one of the one or more clients, a third message indicating that the FL process is terminated or to be terminated at the at least one client in response to the corresponding first message; and transmitting, to at least one of the one or more clients, a fourth message indicating that the at least one client is removed or to be removed from the FL process in response to the corresponding second message. In some embodiments, the fourth message may further indicate a time for the at least one client to quit the FL process.

In some embodiments, the method 1200 may further comprise at least one of: stopping one or more FL operations of the FL process associated with at least one of the one or more clients in response to the transmission of the corresponding first message; stopping one or more FL operations of the FL process associated with at least one of the one or more clients in response to the reception of the corresponding second message; and stopping one or more FL operations of the FL process associated with at least one of the one or more clients in response to the reception of the corresponding third message. In some embodiments, the first message may cause the client to stop one or more FL operations for the FL process. In some embodiments, at least one of the first message, the second message, the third message, and the fourth message may be a message, which is defined in 3GPP TS 23.288, V18.0.0 and/or any of its previous releases, or an extension of the message. In some embodiments, at least one of the first message, the second message, the third message, and the fourth message may be neither a message defined in 3GPP TS 23.288, V18.0.0 and/or any of its previous releases nor an extension of the message.

In some embodiments, the first message may be one of an Nnwdaf_MLModelProvision_Unsubscribe request message and an Nnwdaf_MLTraining_Terminate request message, and/or the third message may be a corresponding one of an Nnwdaf_MLModelProvision_Unsubscribe request message, an Nnwdaf_MLModelProvision_Unsubscribe response message and an Nnwdaf_MLTraining_Terminate response message. In some embodiments, the second message may be one of an Nnwdaf_MLModelProvision_Unsubscribe request message and an Nnwdaf_MLTraining_Quit request message, and/or the fourth message may be a corresponding one of an Nnwdaf_MLModelProvision_Unsubscribe request message, an Nnwdaf_MLModelProvision_Unsubscribe response message and an Nnwdaf_MLTraining_Quit response message.

In some embodiments, before the step of transmitting the first message and/or the step of receiving the second message, the method 1200 may further comprise at least one of: sending, to the one or more clients, ML model information; and receiving, from the one or more clients, ML model information. In some embodiments, an NWDAF may be hosted by the server. In some embodiments, one or more NWDAFs may be hosted by the one or more clients. In some embodiments, the method 1200 may further comprise any of steps in any of the methods described with reference to FIG. 13.

FIG. 13 is a flow chart of an exemplary method 1300 at a server associated with an FL process according to an embodiment of the present disclosure. The method 1300 may be performed at a Server NWDAF (e.g., the Server NWDAF 120-S shown in FIG. 6). The method 1300 may comprise steps S1310 and S1320. However, the present disclosure is not limited thereto. In some other embodiments, the method 1300 may comprise more steps, different steps, or any combination thereof. Further the steps of the method 1300 may be performed in a different order than that described herein. Further, in some embodiments, a step in the method 1300 may be split into multiple sub-steps and performed by different entities, and/or multiple steps in the method 1300 may be combined into a single step.

The method 1300 may begin at step S1310 where the server may receive one or more fifth messages indicating analytics data, which is associated with one or more clients in the FL process and/or one or more candidate clients to be selected for the FL process.

At step S1320, the server may select at least one from the one or more candidate clients and/or the one or more clients for the FL process based on at least the analytics data.

In some embodiments, the one or more fifth messages may be received from at least one of: at least one of the one or more clients; at least one of the one or more candidate clients; and one or more network nodes. In some embodiments, the one or more network nodes may be network nodes assisting the server in collecting analytics data associated with at least one of the one or more clients and/or at least one of the one or more candidate clients.

In some embodiments, before the step of receiving the one or more fifth messages, the method 1300 may further comprise at least one of: transmitting, to at least one of the one or more clients and/or at least one of the one or more candidate clients, a sixth message for subscribing analytics data associated with the at least one client and/or at least one of the one or more candidate clients; and transmitting, to at least one of the one or more network nodes, a sixth message for subscribing analytics data associated with at least one of the one or more clients and/or at least one of the one or more candidate clients. In some embodiments, the fifth messages may be Nnwdaf_AnalyticsSubscription_Notify request messages, wherein the sixth messages may be Nnwdaf_AnalyticsSubscription_Subscribe request messages.

In some embodiments, the analytics data may comprise data related to at least one of: load; availability; capability; latency; and accuracy. In some embodiments, the step of receiving the one or more fifth messages may be performed periodically and/or dynamically in response to an event. In some embodiments, an NWDAF may be hosted by the server. In some embodiments, an NWDAF may be hosted by the one or more clients. In some embodiments, an NWDAF may be hosted by the one or more candidate clients. In some embodiments, the method 1300 may further comprise any of steps in any of the methods described with reference to FIG. 12.

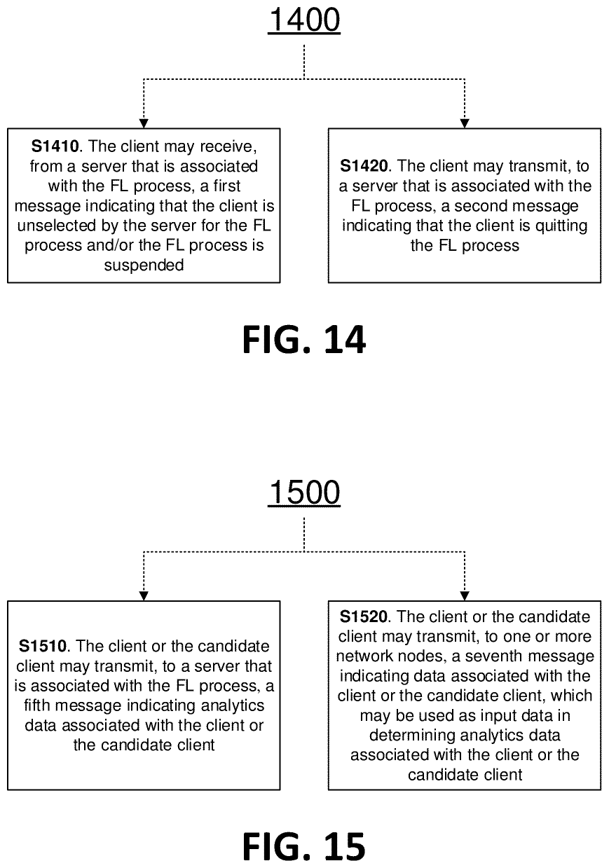

FIG. 14 is a flow chart of an exemplary method 1400 at a client associated with an FL process according to an embodiment of the present disclosure. The method 1400 may be performed at a Client NWDAF (e.g., the Client NWDAF 120-C shown in FIG. 6). The method 1400 may comprise at least one of steps S1410 and S1420. However, the present disclosure is not limited thereto. In some other embodiments, the method 1400 may comprise more steps, less steps, different steps, or any combination thereof. Further the steps of the method 1400 may be performed in a different order than that described herein. Further, in some embodiments, a step in the method 1400 may be split into multiple sub-steps and performed by different entities, and/or multiple steps in the method 1400 may be combined into a single step.

The method 1400 may begin with at least one of steps S1410 and S1420.

At step S1410, the client may receive, from a server that is associated with the FL process, a first message indicating that the client is unselected by the server for the FL process and/or the FL process is suspended.

At step S1420, the client may transmit, to a server that is associated with the FL process, a second message indicating that the client is quitting the FL process.

In some embodiments, at least one of the first message and the second message may further indicate at least one of: an FL Correlation ID; and a cause code. In some embodiments, the cause code may indicate at least one of: the client is unselected by the server for the FL process when the cause code is indicated by the first message; the FL process is suspended when the cause code is indicated by the first message; an availability change associated with the client when the cause code is indicated by the second message; and a capability change associated with the client when the cause code is indicated by the second message.

In some embodiments, the method 1400 may further comprise at least one of: transmitting, to the server, a third message indicating that the FL process is terminated or to be terminated at the client in response to the first message; and receiving, from the server, a fourth message indicating that the client is removed or to be removed from the FL process in response to the second message. In some embodiments, the fourth message may further indicate a time for the client to quit the FL process. In some embodiments, the method 1400 may further comprise at least one of: stopping one or more FL operations of the FL process in response to the reception of the first message; clearing context of the FL process in response to the reception of the first message; stopping one or more FL operations of the FL process in response to the transmission of the second message; clearing context of the FL process in response to the transmission of the second message; and stopping one or more FL operations of the FL process in response to the reception of the fourth message; clearing context of the FL process in response to the reception of the fourth message.

In some embodiments, at least one of the first message, the second message, the third message, and the fourth message may be a message, which is defined in 3GPP TS 23.288, V18.0.0 and/or any of its previous releases, or an extension of the message. In some embodiments, at least one of the first message, the second message, the third message, and the fourth message may be neither a message defined in 3GPP TS 23.288, V18.0.0 and/or any of its previous releases nor an extension of the message.

In some embodiments, the first message may be one of an Nnwdaf_MLModelProvision_Unsubscribe request message and an Nnwdaf_MLTraining_Terminate request message, and/or the third message may be a corresponding one of an Nnwdaf_MLModelProvision_Unsubscribe request message, an Nnwdaf_MLModelProvision_Unsubscribe response message and an Nnwdaf_MLTraining_Terminate response message. In some embodiments, the second message may be one of an Nnwdaf_MLModelProvision_Unsubscribe request message and an Nnwdaf_MLTraining_Quit request message, and/or the fourth message may be a corresponding one of an Nnwdaf_MLModelProvision_Unsubscribe request message, an Nnwdaf_MLModelProvision_Unsubscribe response message and an Nnwdaf_MLTraining_Quit response message.

In some embodiments, before the step of receiving the first message and/or the step of transmitting the second message, the method 1400 may further comprise at least one of: receiving, from the server, ML model information; and sending, to the server, ML model information. In some embodiments, an NWDAF may be hosted by the client. In some embodiments, an NWDAF is hosted by the server. In some embodiments, the method 1400 may further comprise any of steps in any of the methods described with reference to FIG. 15.

FIG. 15 is a flow chart of an exemplary method 1500 at a client that is associated with an FL process or at a candidate client to be selected for the FL process according to an embodiment of the present disclosure. The method 1500 may be performed at a Client NWDAF (e.g., the Client NWDAF 120-C shown in FIG. 6). The method 1500 may comprise at least one of steps S1510 and S1520. However, the present disclosure is not limited thereto. In some other embodiments, the method 1500 may comprise more steps, less steps, different steps, or any combination thereof. Further the steps of the method 1500 may be performed in a different order than that described herein. Further, in some embodiments, a step in the method 1500 may be split into multiple sub-steps and performed by different entities, and/or multiple steps in the method 1500 may be combined into a single step.

The method 1500 may begin with at least one of steps S1510 and S1520.

At step S1510, the client or the candidate client may transmit, to a server that is associated with the FL process, a fifth message indicating analytics data associated with the client or the candidate client.

At step S1520, the client or the candidate client may transmit, to one or more network nodes, a seventh message indicating data associated with the client or the candidate client, which may be used as input data in determining analytics data associated with the client or the candidate client.

In some embodiments, the one or more network nodes may be network nodes assisting the server in collecting analytics data associated with the client or the candidate client. In some embodiments, before the step of transmitting the fifth message, the method 1500 may further comprise at least one of: receiving, from the server, a sixth message for subscribing the analytics data associated with the client or the candidate client; and receiving, from at least one of the one or more network nodes, an eighth message for requesting the input data associated with the client or the candidate client. In some embodiments, the method 1500 may further comprise: collecting, from at least one of one or more NFs, one or more AFs, and one or more OAM nodes, data used for determining analytics data associated with the client or the candidate client; and performing analytics on the collected data to determine the analytics data associated with the client or the candidate client.

In some embodiments, the fifth message may be an Nnwdaf_AnalyticsSubscription_Notify request message, wherein the sixth message may be an Nnwdaf_AnalyticsSubscription_Subscribe request message. In some embodiments, the analytics data may comprise data related to at least one of: load; availability; capability; latency; and accuracy. In some embodiments, the step of transmitting the fifth message may be performed periodically and/or dynamically in response to an event. In some embodiments, an NWDAF may be hosted by the client or the candidate client. In some embodiments, an NWDAF may be hosted by the server. In some embodiments, the method 1500 may further comprises any of steps in any of the methods described with reference to FIG. 14.

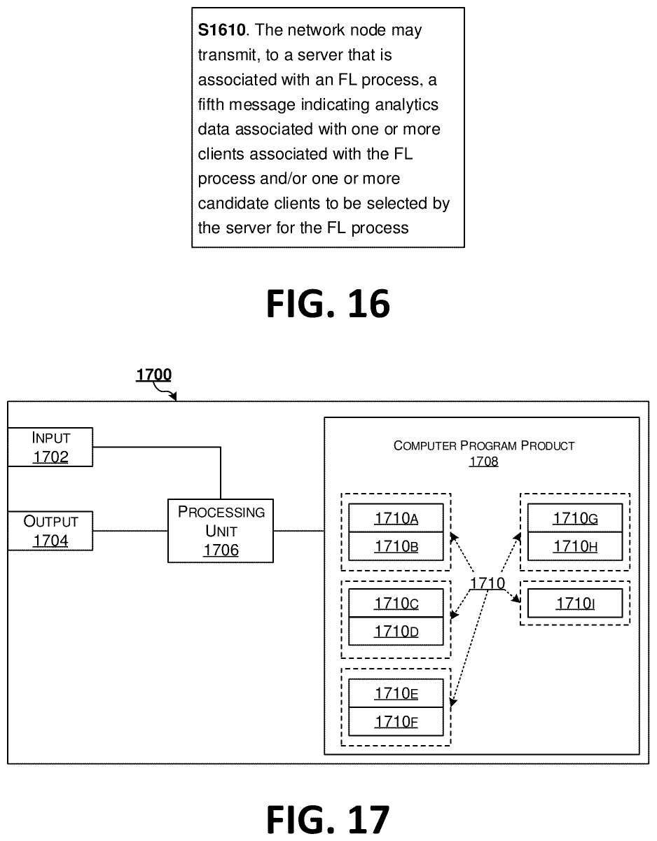

FIG. 16 is a flow chart of an exemplary method 1600 at a network node according to an embodiment of the present disclosure. The method 1600 may be performed at an Assist NWDAF (e.g., the Assist NWDAF 120-A shown in FIG. 6). The method 1600 may comprise a step S1610. However, the present disclosure is not limited thereto. In some other embodiments, the method 1600 may comprise more steps, different steps, or any combination thereof. Further the steps of the method 1600 may be performed in a different order than that described herein. Further, in some embodiments, a step in the method 1600 may be split into multiple sub-steps and performed by different entities, and/or multiple steps in the method 1600 may be combined into a single step.

The method 1600 may begin at step S1610 where the network node may transmit, to a server that is associated with an FL process, a fifth message indicating analytics data associated with one or more clients associated with the FL process and/or one or more candidate clients to be selected by the server for the FL process.

In some embodiments, the network node may be a network node assisting the server in collecting analytics data associated with the one or more clients and/or the one or more candidate clients. In some embodiments, before the step of transmitting the fifth message, the method 1600 may further comprise: receiving, from the server, a sixth message for subscribing the analytics data associated with the one or more clients and/or the one or more candidate clients.

In some embodiments, the fifth message may be an Nnwdaf_AnalyticsSubscription_Notify request message, wherein the sixth message may be an Nnwdaf_AnalyticsSubscription_Subscribe request message. In some embodiments, before the step of transmitting the fifth message, the method 1600 may further comprise: collecting, from at least one of the one or more clients, the one or more candidate clients, one or more NFs, one or more AFs, and one or more OAM nodes, data used for determining analytics data associated with the one or more clients and/or the one or more candidate clients; and performing analytics on the collected data to determine the analytics data associated with the one or more clients and/or the one or more candidate clients.

In some embodiments, the analytics data may comprise data related to at least one of: load; availability; capability; latency; and accuracy. In some embodiments, the step of transmitting the fifth message may be performed periodically and/or dynamically in response to an event. In some embodiments, an NWDAF may be hosted by the client and/or the candidate client. In some embodiments, an NWDAF may be hosted by the server.

FIG. 17 schematically shows an embodiment of an arrangement which may be used in a server, a client, and/or a network node according to an embodiment of the present disclosure. Comprised in the arrangement 1700 are a processing unit 1706, e.g., with a Digital Signal Processor (DSP) or a Central Processing Unit (CPU). The processing unit 1706 may be a single unit or a plurality of units to perform different actions of procedures described herein. The arrangement 1700 may also comprise an input unit 1702 for receiving signals from other entities, and an output unit 1704 for providing signal(s) to other entities. The input unit 1702 and the output unit 1704 may be arranged as an integrated entity or as separate entities.

Furthermore, the arrangement 1700 may comprise at least one computer program product 1708 in the form of a non-volatile or volatile memory, e.g., an Electrically Erasable Programmable Read-Only Memory (EEPROM), a flash memory and/or a hard drive. The computer program product 1708 comprises a computer program 1710, which comprises code/computer readable instructions, which when executed by the processing unit 1706 in the arrangement 1700 causes the arrangement 1700 and/or the server and/or the client and/or the network node in which it is comprised to perform the actions, e.g., of the procedure described earlier in conjunction with FIG. 2 through FIG. 16 or any other variant.

The computer program 1710 may be configured as a computer program code structured in computer program modules 1710A and/or 1710B. Hence, in an exemplifying embodiment when the arrangement 1700 is used in a server associated with an FL process, the code in the computer program of the arrangement 1700 includes at least one of: a module 1710A configured to transmit, to one or more clients that are associated with the FL process, a first message indicating that the corresponding client is unselected by the server for the FL process and/or the FL process is suspended; and a module 1710B configured to receive, from one or more clients that are associated with the FL process, a second message indicating that the corresponding client is quitting the FL process.

Additionally or alternatively, the computer program 1710 may be configured as a computer program code structured in computer program modules 1710C and 1710D. Hence, in an exemplifying embodiment when the arrangement 1700 is used in a server associated with an FL process, the code in the computer program of the arrangement 1700 includes: a module 1710C configured to receive one or more fifth messages indicating analytics data, which is associated with one or more clients in the FL process and/or one or more candidate clients to be selected for the FL process; and a module 1710D configured to select at least one from the one or more candidate clients and/or the one or more clients for the FL process based on at least the analytics data.

Additionally or alternatively, the computer program 1710 may be configured as a computer program code structured in computer program modules 1710E and/or 1710F. Hence, in an exemplifying embodiment when the arrangement 1700 is used in a client associated with an FL process, the code in the computer program of the arrangement 1700 includes at least one of: a module 1710E configured to receive, from a server that is associated with the FL process, a first message indicating that the client is unselected by the server for the FL process and/or the FL process is suspended; and a module 1710F configured to transmit, to a server that is associated with the FL process, a second message indicating that the client is quitting the FL process.

Additionally or alternatively, the computer program 1710 may be configured as a computer program code structured in computer program modules 1710G and/or 1710H. Hence, in an exemplifying embodiment when the arrangement 1700 is used in a client associated with an FL process or a candidate client to be selected for the FL process, the code in the computer program of the arrangement 1700 includes at least one of: a module 1710G configured to transmit, to a server that is associated with the FL process, a fifth message indicating analytics data associated with the client or the candidate client; and a module 1710H configured to transmit, to one or more network nodes, a seventh message indicating data associated with the client or the candidate client, which is used as input data in determining analytics data associated with the client or the candidate client.

Additionally or alternatively, the computer program 1710 may be configured as a computer program code structured in a computer program module 1710I. Hence, in an exemplifying embodiment when the arrangement 1700 is used in a network node, the code in the computer program of the arrangement 1700 includes: a module 1710I configured to transmit, to a server that is associated with an FL process, a fifth message indicating analytics data associated with one or more clients associated with the FL process and/or one or more candidate clients to be selected by the server for the FL process.

The computer program modules could essentially perform the actions of the flow illustrated in FIG. 2 through FIG. 16, to emulate the server, the client, and/or the network node. In other words, when the different computer program modules are executed in the processing unit 1706, they may correspond to different modules in the server, the client, and/or the network node.

Although the code means in the embodiments disclosed above in conjunction with FIG. 17 are implemented as computer program modules which when executed in the processing unit causes the arrangement to perform the actions described above in conjunction with the figures mentioned above, at least one of the code means may in alternative embodiments be implemented at least partly as hardware circuits.

The processor may be a single CPU (Central processing unit), but could also comprise two or more processing units. For example, the processor may include general purpose microprocessors; instruction set processors and/or related chips sets and/or special purpose microprocessors such as Application Specific Integrated Circuit (ASICs). The processor may also comprise board memory for caching purposes. The computer program may be carried by a computer program product connected to the processor. The computer program product may comprise a computer readable medium on which the computer program is stored. For example, the computer program product may be a flash memory, a Random-access memory (RAM), a Read-Only Memory (ROM), or an EEPROM, and the computer program modules described above could in alternative embodiments be distributed on different computer program products in the form of memories within the server, the client, and/or the network node.

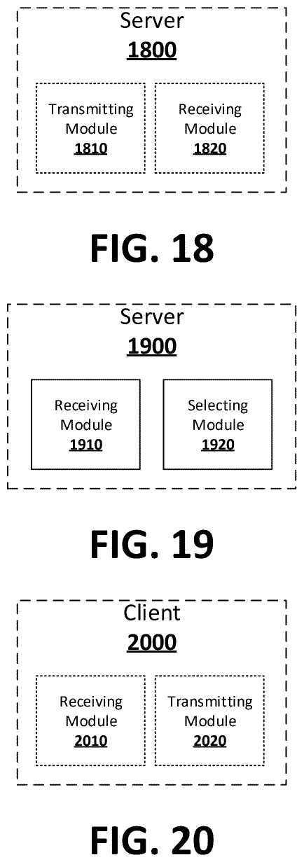

Correspondingly to the method 1200 as described above, an exemplary server associated with an FL process is provided. FIG. 18 is a block diagram of a server 1800 according to an embodiment of the present disclosure. The server 1800 may be, e.g., the Server NWDAF 120-S in some embodiments.

The server 1800 may be configured to perform the method 1200 as described above in connection with FIG. 12. As shown in FIG. 18, the server 1800 may comprise at least one of a transmitting module 1810 configured to transmit, to one or more clients that are associated with the FL process, a first message indicating that the corresponding client is unselected by the server for the FL process and/or the FL process is suspended; and a receiving module 1820 configured to receive, from one or more clients that are associated with the FL process, a second message indicating that the corresponding client is quitting the FL process.

The above modules 1810 and/or 1820 may be implemented as a pure hardware solution or as a combination of software and hardware, e.g., by one or more of: a processor or a micro-processor and adequate software and memory for storing of the software, a Programmable Logic Device (PLD) or other electronic component(s) or processing circuitry configured to perform the actions described above, and illustrated, e.g., in FIG. 12. Further, the server 1800 may comprise one or more further modules, each of which may perform any of the steps of the method 1200 described with reference to FIG. 12.

Correspondingly to the method 1300 as described above, an exemplary server associated with an FL process is provided. FIG. 19 is a block diagram of a server 1900 according to an embodiment of the present disclosure. The server 1900 may be, e.g., the Server NWDAF 120-S in some embodiments.

The server 1900 may be configured to perform the method 1300 as described above in connection with FIG. 13. As shown in FIG. 19, the server 1900 may comprise a receiving module 1910 configured to receive one or more fifth messages indicating analytics data associated with one or more clients in the FL process and/or one or more candidate clients to be selected for the FL process; and a selecting module 1920 configured to select at least one from the one or more candidate clients and/or the one or more clients for the FL process based on at least the analytics data.

The above modules 1910 and 1920 may be implemented as a pure hardware solution or as a combination of software and hardware, e.g., by one or more of: a processor or a micro-processor and adequate software and memory for storing of the software, a PLD or other electronic component(s) or processing circuitry configured to perform the actions described above, and illustrated, e.g., in FIG. 13. Further, the server 1900 may comprise one or more further modules, each of which may perform any of the steps of the method 1300 described with reference to FIG. 13.

Correspondingly to the method 1400 as described above, an exemplary client associated with an FL process is provided. FIG. 20 is a block diagram of a client 2000 according to an embodiment of the present disclosure. The client 2000 may be, e.g., the Client NWDAF 120-C in some embodiments.

The client 2000 may be configured to perform the method 1400 as described above in connection with FIG. 14. As shown in FIG. 20, the client 2000 may comprise at least one of: a receiving module 2010 configured to receive, from a server that is associated with the FL process, a first message indicating that the client is unselected by the server for the FL process and/or the FL process is suspended; and a transmitting module 2020 configured to transmit, to a server that is associated with the FL process, a second message indicating that the client is quitting the FL process.

The above modules 2010 and/or 2020 may be implemented as a pure hardware solution or as a combination of software and hardware, e.g., by one or more of: a processor or a micro-processor and adequate software and memory for storing of the software, a PLD or other electronic component(s) or processing circuitry configured to perform the actions described above, and illustrated, e.g., in FIG. 14. Further, the client 2000 may comprise one or more further modules, each of which may perform any of the steps of the method 1400 described with reference to FIG. 14.

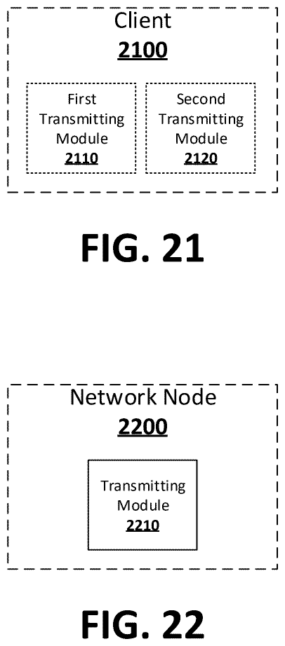

Correspondingly to the method 1500 as described above, an exemplary client associated with an FL process or a candidate client to be selected for the FL process is provided. FIG. 21 is a block diagram of a client or a candidate client 2100 according to an embodiment of the present disclosure. The client or the candidate client 2100 may be, e.g., the Client NWDAF 120-C in some embodiments.

The client or the candidate client 2100 may be configured to perform the method 1500 as described above in connection with FIG. 15. As shown in FIG. 21, the client or the candidate client 2100 may comprise at least one of a first transmitting module 2110 configured to transmit, to a server that is associated with the FL process, a fifth message indicating analytics data associated with the client or the candidate client; and a second transmitting module 2120 configured to transmit, to one or more network nodes, a seventh message indicating data associated with the client or the candidate client, which is used as input data in determining analytics data associated with the client or the candidate client.

The above modules 2110 and/or 2120 may be implemented as a pure hardware solution or as a combination of software and hardware, e.g., by one or more of: a processor or a micro-processor and adequate software and memory for storing of the software, a PLD or other electronic component(s) or processing circuitry configured to perform the actions described above, and illustrated, e.g., in FIG. 15. Further, the client or the candidate client 2100 may comprise one or more further modules, each of which may perform any of the steps of the method 1500 described with reference to FIG. 15.

Correspondingly to the method 1600 as described above, an exemplary network node is provided. FIG. 22 is a block diagram of a network node 2200 according to an embodiment of the present disclosure. The network node 2200 may be, e.g., the Assist NWDAF 120-A in some embodiments.

The network node 2200 may be configured to perform the method 1600 as described above in connection with FIG. 16. As shown in FIG. 22, the network node 2200 may comprise a transmitting module 2210 configured to transmit, to a server that is associated with an FL process, a fifth message indicating analytics data associated with one or more clients associated with the FL process and/or one or more candidate clients to be selected by the server for the FL process.

The above module 2210 may be implemented as a pure hardware solution or as a combination of software and hardware, e.g., by one or more of: a processor or a micro-processor and adequate software and memory for storing of the software, a PLD or other electronic component(s) or processing circuitry configured to perform the actions described above, and illustrated, e.g., in FIG. 16. Further, the network node 2200 may comprise one or more further modules, each of which may perform any of the steps of the method 1600 described with reference to FIG. 16.

The present disclosure is described above with reference to the embodiments thereof. However, those embodiments are provided just for illustrative purpose, rather than limiting the present disclosure. The scope of the disclosure is defined by the attached claims as well as equivalents thereof. Those skilled in the art can make various alternations and modifications without departing from the scope of the disclosure, which all fall into the scope of the disclosure.

| Abbreviation | Explanation |
|---|---|
| 5GC | 5G Core Network |
| AF | Application Function |
| AI | Artificial Intelligence |
| DML | Distributed Machine Learning |
| FL | Federated Learning |
| ML | Machine Learning |
| MTLF | Model Training logical function |
| NEF | Network Exposure Function |
| NF | Network Function |
| NRF | Network Repository Function |
| NWDAF | Network Data Analytics Function |
| OAM | Operations, Administration and Maintenance |

1. A method at a server associated with a Federated Learning (FL) process, the method comprising at least one of:
transmitting, to one or more clients that are associated with the FL process, a first message indicating that the corresponding client is unselected by the server for the FL process and/or the FL process is suspended; and
receiving, from one or more clients that are associated with the FL process, a second message indicating that the corresponding client is quitting the FL process.

2. The method of claim 1, wherein at least one of the first message and the second message further indicates at least one of:
an FL Correlation identifier (ID); and
a cause code.

3. The method of claim 2, wherein the cause code indicates at least one of:
the corresponding client is unselected by the server for the FL process when the cause code is indicated by the first message;
the FL process is suspended when the cause code is indicated by the first message;
an availability change associated with the corresponding client when the cause code is indicated by the corresponding second message; and
a capability change associated with the corresponding client when the cause code is indicated by the corresponding second message.

4. The method of claim 1, further comprising at least one of:
receiving, from at least one of the one or more clients, a third message indicating that the FL process is terminated or to be terminated at the at least one client in response to the corresponding first message; and
transmitting, to at least one of the one or more clients, a fourth message indicating that the at least one client is removed or to be removed from the FL process in response to the corresponding second message.

5. The method of claim 4, wherein the fourth message further indicates a time for the at least one client to quit the FL process.

6. The method of claim 1, further comprising at least one of:
stopping one or more FL operations of the FL process associated with at least one of the one or more clients in response to the transmission of the corresponding first message;
stopping one or more FL operations of the FL process associated with at least one of the one or more clients in response to the reception of the corresponding second message; and
stopping one or more FL operations of the FL process associated with at least one of the one or more clients in response to the reception of the corresponding third message.

7. The method of claim 1, wherein the first message causes the client to stop one or more FL operations for the FL process.

8. The method of claim 1, wherein the first message is one of an Nnwdaf_MLModelProvision_Unsubscribe request message and an Nnwdaf_MLTraining_Terminate request message, and/or
wherein the third message is a corresponding one of an Nnwdaf_MLModelProvision_Unsubscribe request message, an Nnwdaf_MLModelProvision_Unsubscribe response message and an Nnwdaf_MLTraining_Terminate response message.

9. The method of claim 1, wherein the second message is one of an Nnwdaf_MLModelProvision_Unsubscribe request message and an Nnwdaf_MLTraining_Quit request message, and/or
wherein the fourth message is a corresponding one of an Nnwdaf_MLModelProvision_Unsubscribe request message, an Nnwdaf_MLModelProvision_Unsubscribe response message and an Nnwdaf_MLTraining_Quit response message.

10. The method of claim 1, wherein before the step of transmitting the first message and/or the step of receiving the second message, the method further comprises at least one of:
sending, to the one or more clients, Machine Learning model information; and
receiving, from the one or more clients, ML model information.

11-12. (canceled)

13. A method at a server associated with an FL process, the method comprising:
receiving one or more fifth messages indicating analytics data, which is associated with one or more clients in the FL process and/or one or more candidate clients to be selected for the FL process; and
selecting at least one from the one or more candidate clients and/or the one or more clients for the FL process based on at least the analytics data.

14. The method of claim 13, wherein the one or more fifth messages are received from at least one of:
at least one of the one or more clients;
at least one of the one or more candidate clients; and
one or more network nodes.

15. The method of claim 14, wherein the one or more network nodes are network nodes assisting the server in collecting analytics data associated with at least one of the one or more clients and/or at least one of the one or more candidate clients.

16. The method of claim 13, wherein before the step of receiving the one or more fifth messages, the method further comprises at least one of:
transmitting, to at least one of the one or more clients and/or at least one of the one or more candidate clients, a sixth message for subscribing analytics data associated with the at least one client and/or the at least one candidate client; and
transmitting, to at least one of the one or more network nodes, a sixth message for subscribing analytics data associated with at least one of the one or more clients and/or at least one of the one or more candidate clients.

17. The method of claim 13, wherein the fifth messages are Nnwdaf_AnalyticsSubscription_Notify request messages,
wherein the sixth messages are Nnwdaf_AnalyticsSubscription_Subscribe request messages.

18. (canceled)

19. The method of claim 13, wherein the step of receiving the one or more fifth messages is performed periodically and/or dynamically in response to an event.

20-21. (canceled)

22. A server, comprising:
a processor;
a memory storing instructions which, when executed by the processor, cause the processor to:
transmit, to one or more clients that are associated with the FL process, a first message indicating that the corresponding client is unselected by the server for the FL process and/or the FL process is suspended; and
receive, from one or more clients that are associated with the FL process, a second message indicating that the corresponding client is quitting the FL process.

23. A method at a client associated with an FL process, the method comprising at least one of:
receiving, from a server that is associated with the FL process, a first message indicating that the client is unselected by the server for the FL process and/or the FL process is suspended; and
transmitting, to a server that is associated with the FL process, a second message indicating that the client is quitting the FL process.

24-42. (canceled)

43. A client, comprising:
a processor;
a memory storing instructions which, when executed by the processor, cause the processor to;
receive, from a server that is associated with the FL process, a first message indicating that the client is unselected by the server for the FL process and/or the FL process is suspended; and
transmit, to a server that is associated with the FL process, a second message indicating that the client is quitting the FL process.

44-56. (canceled)

57. A server, comprising:
a processor;
a memory storing instructions which, when executed by the processor, cause the processor to:
receive one or more fifth messages indicating analytics data, which is associated with one or more clients in the FL process and/or one or more candidate clients to be selected for the FL process; and
select at least one from the one or more candidate clients and/or the one or more clients for the FL process based on at least the analytics data.
